(19) United States
(12) Patent Application Publication
(10) Pub. No.: US 2006/0265255 A1
(43) Pub. Date: Nov. 23, 2006

(54) System for monitoring health insurance coverage milestones, tracking member expenses & payments and administration tool for health/medical saving accounts

(76) Inventor: Cary J. Williams, Cypress, TX (US)

Correspondence Address: LAW OFFICE OF DAVID MCEWING, P.O. BOX 231324, HOUSTON, TX, 77023, US

(21) Appl. No.: 11/435,637

(22) Filed: May 17, 2006

Related U.S. Application Data
(60) Provisional application No. 60/682,694, filed on May 19, 2005.

(51) Int. Cl. G06Q 40/00

(52) U.S. Cl. 705/4

(57) ABSTRACT

A system and tool that stores and tracks all member healthcare and prescription expenses, using private and secure Internet accounts to monitor payments of their Managed Care (HMO/PPO) provider or insurer. A management tool that has the ability to track and administrate Health/Medical Saving Accounts and also tell a member based on the total amount of any expense what they should expect the insurer to pay and what they (member/insured) should expect to pay towards that expense. The invention utilizes expense tracking computer software that automatically alerts members when the insurer has failed to pay the full amount of medical expenses as required under the medical insurance policy. The customer service component of the invention allows the initiation of contact with that member's Managed Care (HMO/PPO) or insurer to discuss the issue of payment on behalf of that member. The tool includes the ability to work as an ombudsman for members with benefit management online with their HMO/PPO, healthcare provider or employer to work towards positive resolution on expense, coverage or problem/issues and question for members offering supplemental or itemized bill review. The tool may include pre-paid legal assistance when ombudsman services can't resolve a member issues, expenses, or healthcare needs.

### RELATED APPLICATION

This application claims priority to provisional application 60/682,694 entitled “System for Tracking Insurance Milestones and Payments with Policy and Plan Provisions” and filed May 19, 2005.

### BACKGROUND OF INVENTION

1. Technical Field

The invention pertains to administrating, monitoring and management of member health care expenses, and the ability to administrate health/medical saving account payment/reimbursement involving medical expenses and insurance.

2. Related Art

Insurance companies, employers, or a third party administrator provide telephone banks accessible to its insured providing listings of filed claims and the status of payments.

### SUMMARY OF INVENTION

A system that stores and tracks all member healthcare expenses, using private and secure Internet accounts to monitor payments of their Managed Care (HMO/PPO) provider or insurer. A system that has the ability to track and administrate Health/Medical Saving Accounts and also tell a member based on the total amount of any expense what they should expect the insurer to pay and what they (member/insured) should expect to pay towards that expense. The invention utilizes expense tracking computer software that automatically alerts members when the insurer has failed to pay the full amount of medical expenses as required under the medical insurance policy. The customer service component of the invention allows the initiation of contact with that member's Managed Care (HMO/PPO) or insurer to discuss the issue of payment on behalf of that member. The system also includes an ombudsman to administer inquiries between members and insurers with benefit management online their HMO/PPO, healthcare provider or employer to work towards positive resolution on expense, coverage or problem/issues and question for members offering supplemental or itemized bill review and pre-paid legal assistance when a system administer can't resolve a member issues or healthcare needs.

The invention pertains to monitoring insurance payment of medical event expenses for compliance with the terms of the insurance policy. The invention can include a system for entering insurance payment obligations, entering medical expense event information, calculating dollar value of insurance payment obligation for expense event, entering dollar value of actual insurance payment, evaluating actual insurance payment with event payment obligation, and marking expense event for inquiry if event payment obligation exceeds actual insurance payment.

### SUMMARY OF DRAWINGS

Diagram 1 contains a high level outline of the functions of the invention, including user account management.

Diagram 2 illustrates an embodiment of the steps that may be taken to establish a user membership or for a member user to log into the invention.

Diagram 3 iMed Internet Architecture.

Diagram 4 illustrates a member user accessing the account summary page of the invention. Illustrated are the options presented to the user including adding or editing member milestones, adding or editing members and personal data, etc.

Diagram 4C illustrates steps that can be taken through the “add/edit member milestone” option including modification of insurance policy terms and information.

Diagram 4E illustrates the centralized function of the account management function of the invention. Included is the transition from the account summary page to account page and then to functions such as event (payment) management and inquiry management.

Diagram 5 illustrates the steps of creating an event wherein medical expenses are incurred and the user's insurance policy participation is monitored for compliance with policy payment obligations. This process commences from the account page.

Diagram 6A illustrates event tracking and alert system. The medical expense is evaluated with the medical insurance payment obligations. Comparison is made of actual payment and calculated or expected payment.

Diagram 6B illustrates optional embodiment wherein system makes inquiry on user behalf to resolve discrepant payment contribution for medical event.

Diagram 7A illustrates steps of an embodiment in which user makes inquiry to the system of the invention. Time devoted or expended in this inquiry function is assessed against a paid time allocation. This process commences from the account page.

Diagram 7B is a continuation of the steps illustrated in Diagram 7A. Reporting of resolved inquires is illustrated. Members are notified of inquiry status vial email.

Diagram 8 iMED Patient Selection

Diagram 9A illustrates another embodiment of the invention wherein members may communicate with system representatives. Again this process starts from the account page.

Diagram 9B further illustrates the “live chat” option.

Diagrams 9C, 9D and 9E illustrate embodiments of member user technical support, again commencing from the account page.

Diagram 10A illustrates the process steps wherein a member user may access a summary of the insurance policy over the Internet.

Diagram 10B illustrates an embodiment wherein the member user may modify policy milestones. This step can be implemented from the account summary page.

Diagram 10C illustrates the option wherein the user member may be provided an electronic copy of the actual medical insurance policy.

Diagram 11A illustrates an embodiment wherein prescription drug payment may be tracked. This process again starts from the account page.

Diagram 11B illustrates an embodiment wherein the member user may modify prescription drug history and payment.

Diagrams 12A through 12G illustrate the account functions that can be performed by the system associate in one embodiment of the system.

Diagram 13 illustrates steps for administrative view of medical events.

Diagram 14 illustrates the steps for viewing event details.

Diagram 15 illustrates the steps for correcting medical event entry and particularly for an “over charge” event.

Diagram 16 illustrates steps for system associate to add a new medical event.

Diagram 17 illustrates the steps for system associate to viewing medical events.

Diagram 18 illustrates the steps viewing prescriptions from the account page.

Diagram 19 illustrates the steps to view member inquiries beginning from the account page.

Diagram 20 illustrates the steps to edit a member account.

Diagram 21 illustrates the steps to edit member patient information.

Diagram 22 illustrates the steps to add a new member patient.

Diagram 23 illustrates the steps to delete a patient account.

Diagram 24 illustrates the steps of sending a password to a member.

Diagram 25 illustrates the steps of editing account card information. Credit card information will be utilized for a member to purchase more customer service minutes.

Diagram 26 illustrates the steps to edit a member's health insurance contract milestone information.

Diagrams 27 through 56 illustrate administrative functions of one embodiment of an application program of the system

These accompanying figures, which are incorporated in and constitute a part of the specification, illustrate embodiments of the invention. The figures, together with the general description of the invention given above and the detailed description of the preferred embodiments given below, serve to explain the principles of the invention. These figures are provided for illustration and explanation and do not limit the scope of the invention.

### DETAILED DESCRIPTION OF INVENTION

It is well known that the costs of medical treatment have increased dramatically in recent years, typically outpacing the cost increases of other segments of the national economy. The role of third party payment entities has also changed, typically with growing complexity and with greater sharing of costs with the beneficiary or “insured”. Third party payment or expense reimbursement entities include traditional health insurance companies, third party administrators, and Health Saving Account/Medical Savings Account (HSA/MSA) manager/administrators. These entities also include managed care providers such as health maintenance organizations (“HMOs”) and preferred provider organizations (“PPOs”). All third party payors, health maintenance organizations, and expense reimbursement entities are referred to within this specification as “health insurers” or “insurers”. Further, health maintenance organization or group plans, PPO plans, health insurance or medical insurance plans or policies or however else termed for third party payment of medical or health expenses (including prescription drug expenses) are hereinafter termed “insurance contracts”.

These entities frequently have lists of established pre-qualified or pre-approved health care providers forming a network. The health care cost reimbursement provided to the insured by these entities may vary depending upon whether the health care provider is pre-approved or otherwise within the “network”. Costs incurred with an “out of network” health care provider may not be subject to reimbursement, e.g., not covered an insurance contract, or may be subject to reduced reimbursement, i.e., a smaller percentage of the total cost being paid by the insurer with payment of the remainder being the responsibility of the insured or a pre-tax or tax exempt/deferred payment or reimbursement by a HSA/MSA network administrator. The system subject of this invention may be utilized by HSA/MSA network providers.

Conversely, the health care provider may be within the insurer's network but the specific service may not have been pre-approved. These factors may be material to whether the expense may be reimbursed or the amount e.g., percentage, of the cost that will be reimbursed.

Of course certain treatments or health conditions may not be subject to reimbursement, e.g., non-covered expenses. One example is cosmetic surgical procedures are typically not covered by a medical insurance contract. Additionally, treatment procedures may not be covered by the insurance contract if deemed by the insurer to be experimental or not within the scope of customary or accepted medical practice.

All of the above factors, i.e., increased costs and increased complexity of insurance contract coverage, create an ever increasing burden for the individual insured. In other words, it is becoming increasing burdensome for the insured to know if the insurer is paying all covered medical or health care costs as obligated under the applicable insurance contract. It may also not be possible to know if the insured is getting the full medical treatment benefit from the insurer. The full scope of covered benefits provided by the insurance contract may not be easily understood.

Related to the complexity of the terms of contract coverage, the administrative and management procedures of the insurer and the health care provider may also discourage the insured from effectively monitoring the insurer's compliance with the terms of the insurance contract. Challenging a payment determination made by the insurer may not only be time consuming, emotionally frustrating but require the insured to acquire knowledge of healthcare administration and terminology and insurance contract or health maintenance administration or terminology. The invention provides a tool that minimizes these issues for members.

The invention subject of this disclosure includes a system that collects health care related costs incurred by an insured, and compares or evaluates the payment of these costs (“actual insurer payments”) by an insurer with the obligations, i.e., terms, of the applicable insurance contract (“calculated insurer payment obligations” or “X+pect to pay”). The costs paid by the member are also tracked. This can include payments made through Health Savings Accounts. The system includes a system administrator (hereinafter “associate”). If the system detects that insurer's payments do not comply with the contract terms, the insured may be notified. Further, the system may include resources (a “customer service” component described below) whereby inquiry may be made within the system by insured or on behalf of the insured to the insurer to resolve a noted expense error or an event of contract or policy non-compliance.

Inquiry to the insurer may include presentation of information and records. Medical records and receipts may be electronically scanned and transmitted to the system of the invention. With member authorization, the information may be transmitted to an insurer to support a claim for further payment. Where necessary, the associate may participate in calls among the member and insurer or as an ombudsman on behalf of member to resolve the issue directly with insurer.

The system subject of the invention may also include (in addition to medical expense tracking), tracking of eligible preventive therapy or wellness benefits, claim processing, billing and remittance, reporting and analytics and electronic billing and document management. For example, the system may handle the billing and payment of deductibles from HSA/MSA accounts. In another example, it may create a database from which insurer payment and coverage trends may be reported and analyzed. Utilizing electronic scanning and portability of electronic documents, members may utilize the system to manage their health care records, including but not limited to reports, diagnostics, test results, histories, as well as billing and payment records.

A member's level of participation with the system subject of the invention may vary. For example, the tracking of health care expenses (hereinafter “medical expense event”) may be provided at little or no cost. The benefit of associate inquiry on behalf of the member insured (hereinafter “member”) may be dependant upon payment of varying levels of membership fees or similar arrangements. A member may purchase additional customer service minutes through accessing his/her account summary page as discussed further herein.

A “member” is deemed to include all beneficiaries or plan participants, e.g., family members of the insured. Membership maybe paid through an annual enrollment fees or paid through monthly installments. Payment may be through the member's employer or other membership organization. Payment can be through payroll deduction or as an allocation from other membership dues. Alternatively, the membership costs may be paid by the member's employer. In yet another embodiment, the member's costs may vary with usage and/or be paid through credit card or through automatic account withdrawals or bank drafts. In an additional embodiment, the system may be compensated from a percentage of actual additional recovery.

An individual insured may participate in the system by individual subscription or as a member in a larger organization, including as an employee of a participating or subscribing employer. Group participation may be through other means such as membership in a fraternal organization or labor union.

The invention includes a customer service component that can respond to member questions. For example, the member may request a bill review or audit of medical charges. The member may request deductible payments be paid from an HSA account. This customer service component may, at the member's request and authorization, also make inquiry to the insurer on behalf of the member regarding insurance contract payment of medical expenses. This inquiry may include efforts to resolve or mediate issues regarding actual insurer payments not complying or matching the calculated (“x-pect to pay”) insurer payment obligations (“non-compliance”). Resolution may be correction of inputted data, additional payment by the insurer, revision or amendment of a service provider invoice, etc. In this role, the system associated may serve as an ombudsman investigating disputes, reporting facts and mediating fair settlements. The system creates and maintains the data base which may facilitate the associates' role as ombudsman to respond to member questions and initiate inquiries or mediate resolutions. The role of the ombudsman mitigates the difficulty of an individual member navigating the health insurance and health care bureaucracy.

The amount of customer service time utilized by the member or expended on behalf of a member may be tracked within the system. In one embodiment, the member maybe entitled to a “prepaid” amount of customer service time through a basic membership package. Additional time may be “purchased” by the member. Obviously a member alerted to a significant monetary discrepancy between actual insurer contract payment and the calculated insurer payment obligation under the contract may wish to purchase additional customer service time in order to achieve the insurer's compliance with contract obligations. Alternatively, the member may elect to attempt to achieve resolution through his/her own efforts.

In another embodiment, the member may elect a plan package that entitles the member to unlimited customer service time. An alternative arrangement may include the system retaining a portion of any additional payment or reimbursement received by the insured.

In yet another embodiment, the invention includes the ability of the member to acquire pre-paid legal services. This legal representation would be directed to providing advocacy and representation for disputes with the insured regarding insurance coverage and payments that can not be resolved through a system associate ombudsman. Payment of these services could be included in the enrollment or membership fees paid by the member. Membership would permit relevant information (event data and insurance payment information, contract terms and evaluations of payment obligations and discrepant payment history) being made available to the member's authorized representative; thereby facilitating a seamless transition in resolution of disputes.

It will be appreciated that one embodiment of the system subject of the invention facilitates the centralized collection of member medical event information, including dates, services, payments, etc. all in a format that is adaptable to insurance administrators. The member thus has access to a record system, designed for the member's benefit, which facilitates the audit and mediation of contractually obligated benefits and payments. The system provides a tool that enables the member to more productively deal directly with the insurer.

The system may also possess continuously updated and detailed knowledge of insurance practices and polices and terms. Coverage terms may continue to evolve and be amended. The insurance contract terms may vary depending upon plan type. The system subject of the invention may assemble an extensive database of policy terms and coverage determinations which may be accessed in responding to customer service requests and member inquires. This data base may also facilitate the ombudsman function of the system. This aspect of the system may also permit the analysis and reporting of medical events, treatment, insurance coverage and payment.

In the preferred embodiment of the invention, the member sets a predetermined limit or threshold which triggers the marking of a medical expense event for customer service inquiry. For example, a medical expense event may total $1000.00 and the insurer's payment obligation may be calculated to be $800.00 under the terms of the policy. For various reasons the insurer may actually pay an amount less than $800.00, thereby increasing the portion of the total expense that must be paid by the member. The member may agree that only non-compliance events of an amount of $50.00 or more will be marked for customer service inquiry. Therefore, if the insurer only pays $795.00 in contrast to the calculated the $800.00, the system may not flag the event for inquiry. However, if the insurer only pays $705.00, creating a non-compliance amount of $95.00, the event will be automatically flagged for the member's attention and for possible inquiry by system associates on behalf of the member. Each member can pre-select the threshold value for marking or alert. This limit may also be re-set or modified at any time.

In one embodiment of the invention, the system permits member access via the Internet. Internet access can allow member enrollment, private/secure login accounts for data inputting and editing, and communication with the administrator or customer service. Communication may be through “live chat” or “live talk”, i.e., “voice over IP”, or internal email. Members may also communicate with a system associate or customer service via telephone or by mail. It is envisioned that as a management and cost control tool, most communication will be through electronic means, i.e., email, live electronic chat, or notations/comments accompanying data input or editing.

The utilization of Internet functionality permits on line storage, data inputting and data retrieval of medical events and member insurance milestone information. Medical event information can include the date and purpose of a medical expense event, i.e., an event causing the member or family member incurring a medical expense. Where appropriate, this data can include the classification of the expense in terms of whether it was incurred with an “in-network” health care professional, incurred as a pre-approved procedure or treatment, or conversely whether it was incurred through an out of network health care provider or without pre-authorization or referral.

Records (receipts, member copies of medical diagnosis, etc., from health care providers) may be paperless and stored in PDF, TIFF or JPEG or similar electronic format. These records may be stored on memory components of the system accessed by servers.

Insurance contract milestone information can include tracking of In-Network/Out-Network expenses chargeable to an insurance deductible, co-pay, co-insurance or plan year out-of-pocket expense limit. Thus one component of the invention is the ability to track and summarize the incurrence of medical expenses, the payment or reimbursement of these expenses under an insurance contract or HSA (Health Saving Account) payment/reimbursement and administration, evaluation of actual payment/reimbursement (hereinafter “actual insurer payment”) and calculated payment obligation under the term of the applicable insurance policy (hereinafter “calculated insurer payment obligation” or “x-pect to pay”), and status of yearly deductible and out-of-pocket expense limitations. The information may be viewed on a year to date basis or upon a per event basis.

Data input can be supplied from multiple sources. Basic payment obligations, such as member co-pay, deductible, out of network and in-network payments obligations may be obtained or verified directly from the insurer or the employer/employee. Such data may include the insurance milestones or allow calculation of such milestones. In addition, the insurer may supply the medical expense event data, including the identity of the health care provider, the member or member's family member receiving treatment, the date of treatment, the total expense, the amount actually paid by the insurer, etc. The member may also furnish all or some of this information, or be able to verify the accuracy of the insurer furnished data and or payment or furnish reimbursement receipts for repayment from a pre-tax or tax deferred HSA (Health Saving Account). Utilizing member furnished information that is prompted by the system to be correctly and timely inputted may correct insurer information, thereby enhancing the members' receipt of contractually obligated insurance benefits.

The calculated insurer payment obligation step utilizes the inputted invoice amount of a medical expense event and calculates the amount that the insurer is obligated to pay pursuant to the terms of the contract. This calculation includes the amount of the policy deductible, the amount of the deductible previously paid by the member, whether the service provider was In-network/Out-network, etc.

The invention also includes the web server including computer network and related components connected to the Internet providing member access to the content of the system. The inputted data, calculated insurer payment obligations, customer service inquiries, etc. may be stored within memory devices including the memory component of one or more CPUs controlled by one or more servers. The system communicates with members and insurers by mechanisms including but not limited to the Internet, including internal or regular email and the World Wide Web. The system may be accessed by the member and customer service. The system utilizes account tracking logic built into its application program that evaluates all inputted events and payments to insure compliance with insurer payment obligations.

Thus the invention includes a private/secure database accessible by members and through customer service. The insurer, in one embodiment, may be able to input data, such as a new medical expense event or information of a payment made to a healthcare provider. However the insurer's access would be limited and may or may not include communications between customer services and the member or notations made by either customer service or the member.

Diagram 1, entitled “iMed Audit High Level Workflow” illustrates that there may be two differing accounts offered by the system subject of the invention, i.e., individual/family accounts 101 and corporate accounts 102. If the user, starting from a home page, is an individual or family member, the user will be directed to the enter the website 104 and also participate in the account creation process 105 as discussed more thoroughly in Diagram 2. As an overview, the system also includes account management process 106, 107 and described in Diagram 4. In one embodiment, the account management function and service utilizes the application program tracking logic software for monitoring milestones and payments. Alternate systems may be used.

Once the account management step is completed, the member may receive alerts of payment non compliance 108 as well as later modify their plan membership, or other relevant information 109.

Diagram 2, entitled “Account Creation Workflow” details one embodiment of the startup process of membership in the service (business method) subject of this invention. Beginning from the business homepage 120, the user is queried whether he/she is a member 201. Starting with the non-member 202, the user may select among various plan levels 204. These options can include level of prepaid customer support and administrative service that may be provided. The user may be invited to provide an email address 205. In the embodiment illustrated, payment is made and accepted, along with emailed user id 206, 207, 208. At this point, the user may now link 209 to the member login page 210. A security challenge/procedure may be implemented 211, 212, 213, 214. The user (now “member”) is directed to new account setup.

The member provides authorization and consent 216 for the system to obtain medical and insurance payment information upon the member's behalf and disclose such information in course of processing and administering inquiries on the member's behalf.

The member is directed to the account creation page 217. One action of this step is the member designating the insurance plan through which coverage is provided. This will include disclosure of the standard policy information including but not limited to insurance company, plan type, co-pays, deductibles, employer, beneficiary, covered insured, social security numbers, etc, 218. Other personal information may be collected 219. The inputted information is submitted to the system and the personal information saved to database 220, 221. The product is an account summary page 222 showing the member's account based upon the applicable insurance policy.

It will be understood that an existing member will proceed directly from the member login 210 entering user id and password 212 and through the security protocol to the account summary page 222.

In the embodiment described, the member may proceed from the account summary page to a number of options. These steps 401 are illustrated in Diagrams 4, 4C, 4D and 4E. Generally, the member may “add/edit member policy milestone information”, “add/edit members and personal data”, input “customer service access”, and multiple “account functions via Account Page”.

In addition, the member is able 402 to “view member messages/alerts”, “view customer service minutes” “view account totals” access “links to stories and information” and access “links to discounted services.” The member may also purchase additional customer service minutes. The member may also choose to upgrade his/her membership to allow unlimited membership.

Diagram 4C entitled “iMed-Audit Member Policy Info Management” illustrates the one embodiment for a member to update policy information. Beginning with the account summary page, the member may click a “modify” button associated with the “add/edit member policy milestone information”. This may allow the member to modify 405 the policy type, policy name, yearly deductible amount, yearly out-of-pocket, coinsurance, medical savings account, lifetime maximum, etc. The member may also modify information such as member name and birth date, etc. In the embodiment illustrated, the member is queried 406 if more changes are needed. The member may click “close” 408 and be returned 409 to the account summary page.

Diagram 4E, entitled “iMed-Audit Account Management” illustrates an embodiment of process steps through the system subject of the invention wherein the process again begins from the account summary page and particularly from the “account functions via the account page”. The member may enter the event management system 451, the inquiry management system 452, patient selection 453, prescription management 454, customer service 455 and policy summary 456.

Each of these functions and services will be described in greater detail.

Diagram 5, entitled “iMed Event Creation and Modification” illustrates an embodiment of one facet of the invention. Beginning from the account page link 401 of the account summary, the member clicks “enter new event” 451. The member is then prompted to enter information 501 including “type of care”, “in network”, “Emergency”, “co-pay” “care date”, “ICD-9 Codes”, “procedure”, “patient name”, “care provider”, “event description”, “Bill ID”, “Bill amount”, “Paid insurance”, “Paid insured”, “comments”. The information is submitted 502 to the system. The comments may be coded or indexed for retrieval or storage for later customer service or ombudsman fact gathering or mediation. It will be appreciated that data may be solicited and inputted via an Internet using a field to be populated with the information. The invention also provides the members the ability to edit or modify 504 the event information. The member may click the “+View Details” link 505 and the window is opened illustrated as FIG. 5-2 551. The member may click “Click here to Edit changes” 507, displaying 508 the window illustrated as FIG. 5-3 552. The edited changes may be submitted 509.

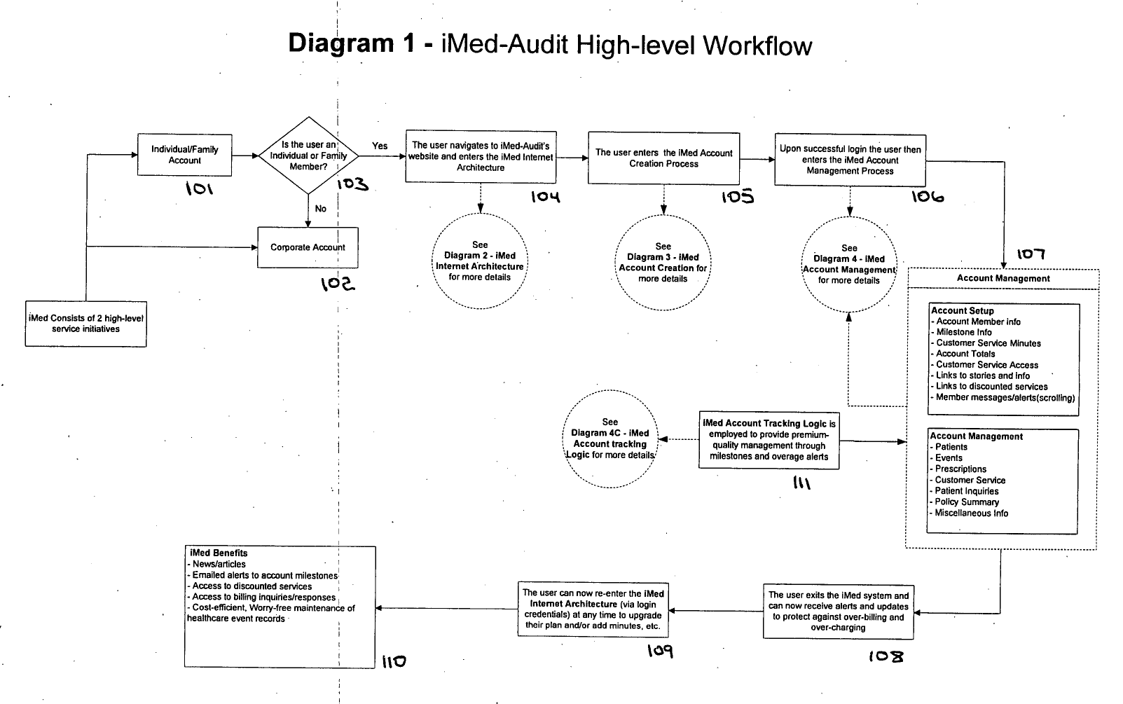

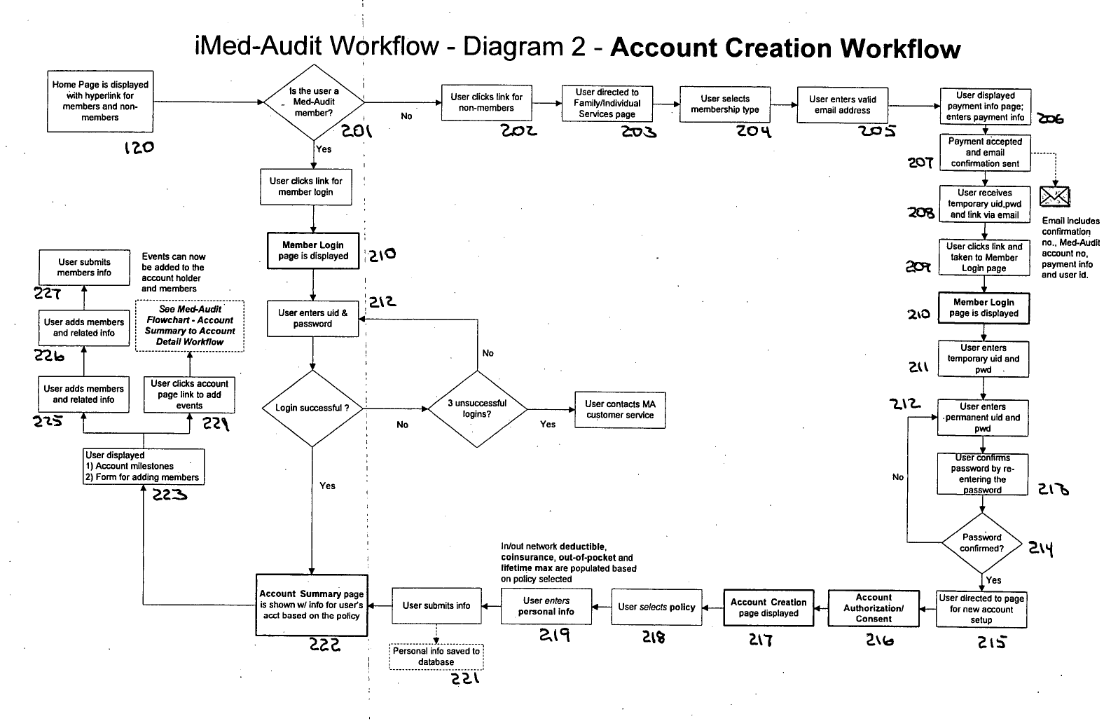

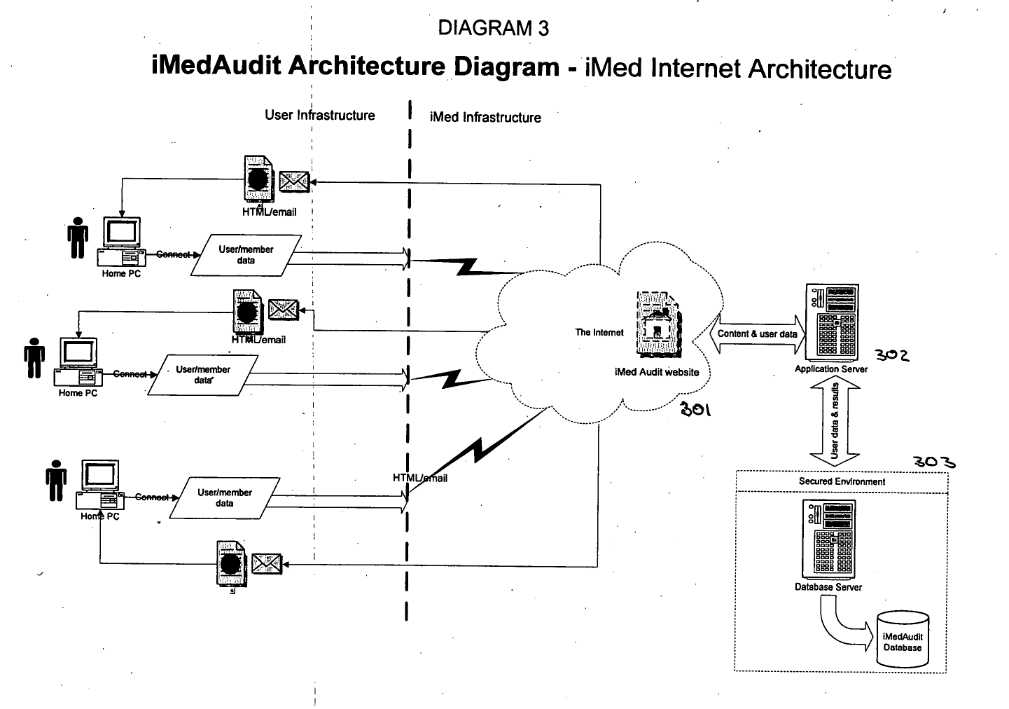

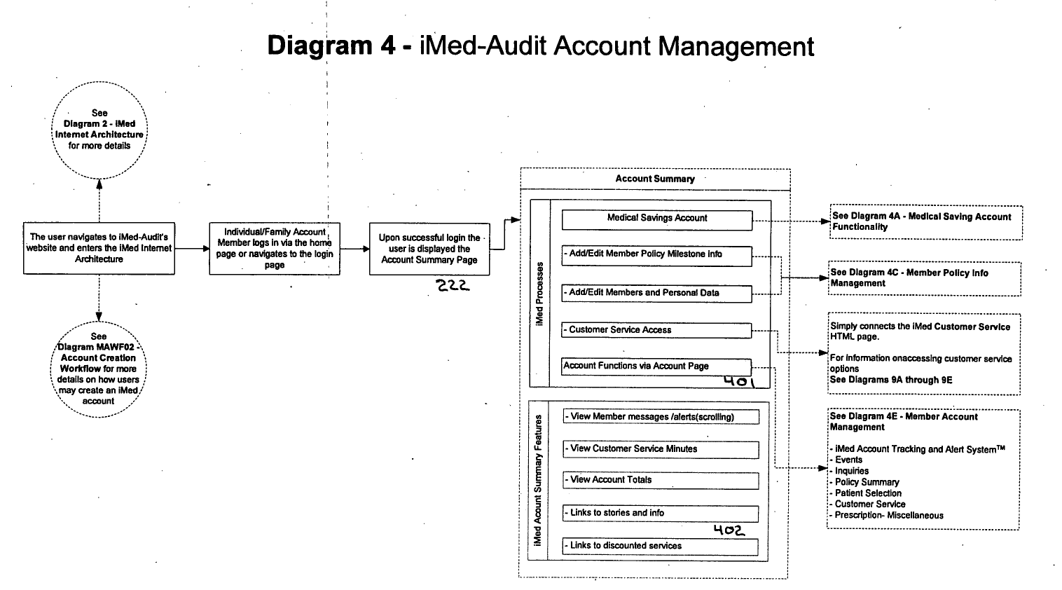

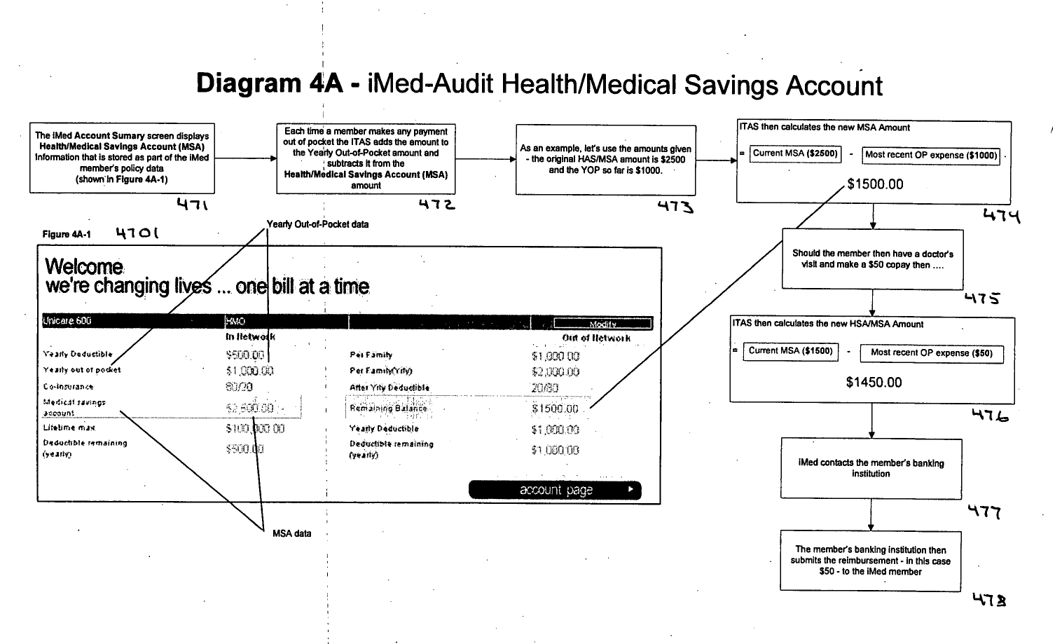

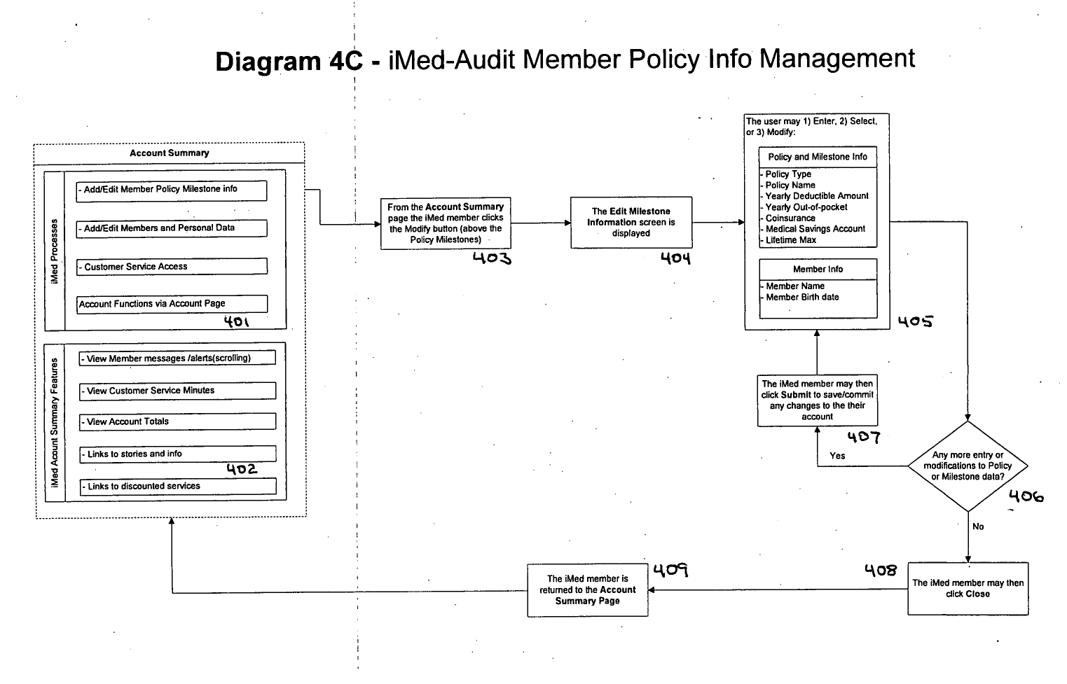

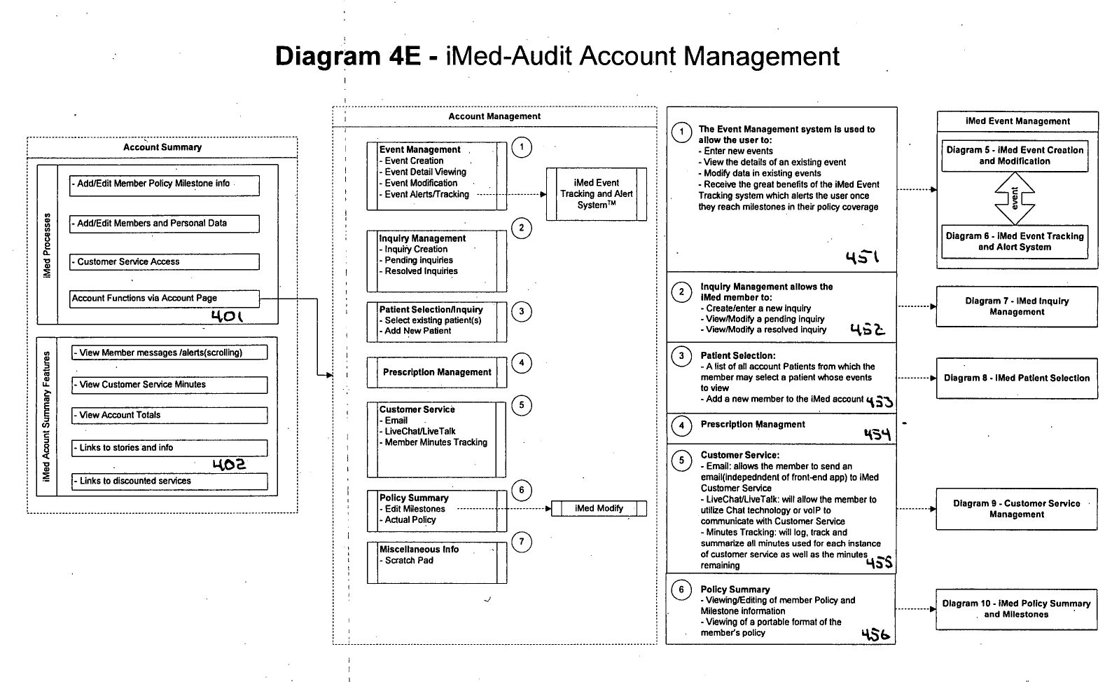

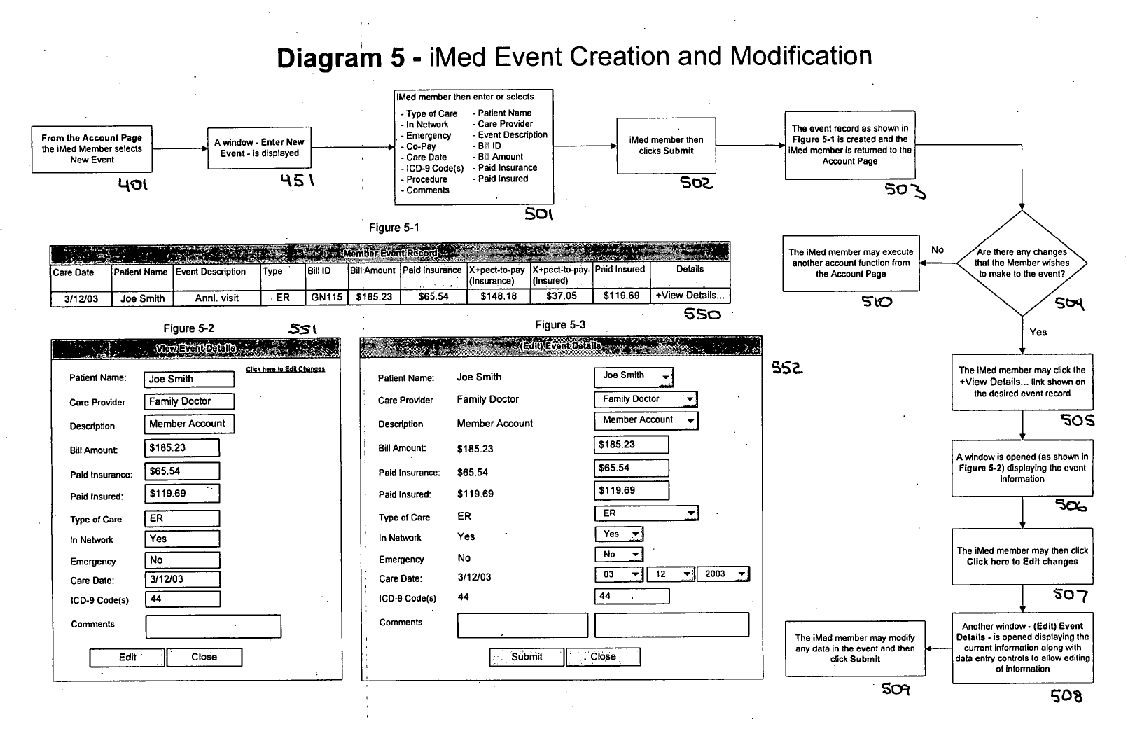

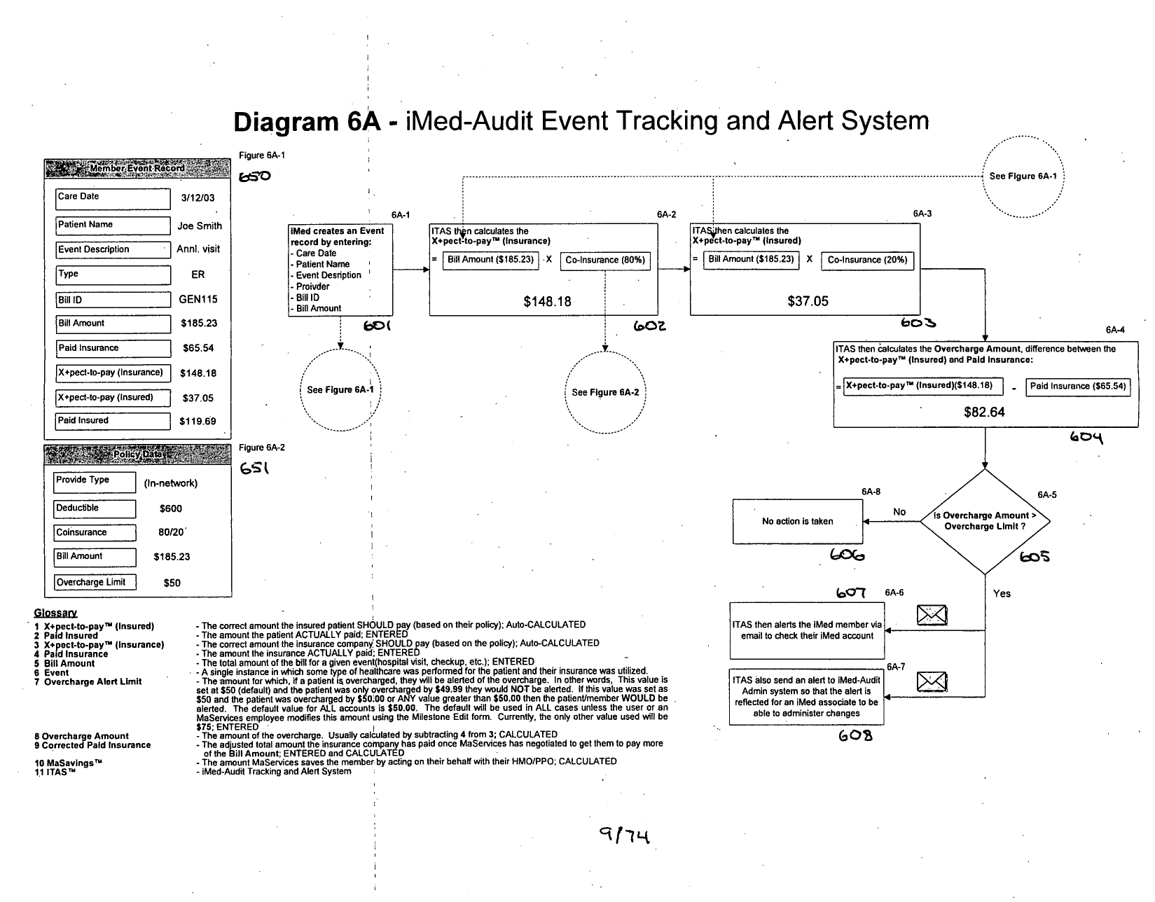

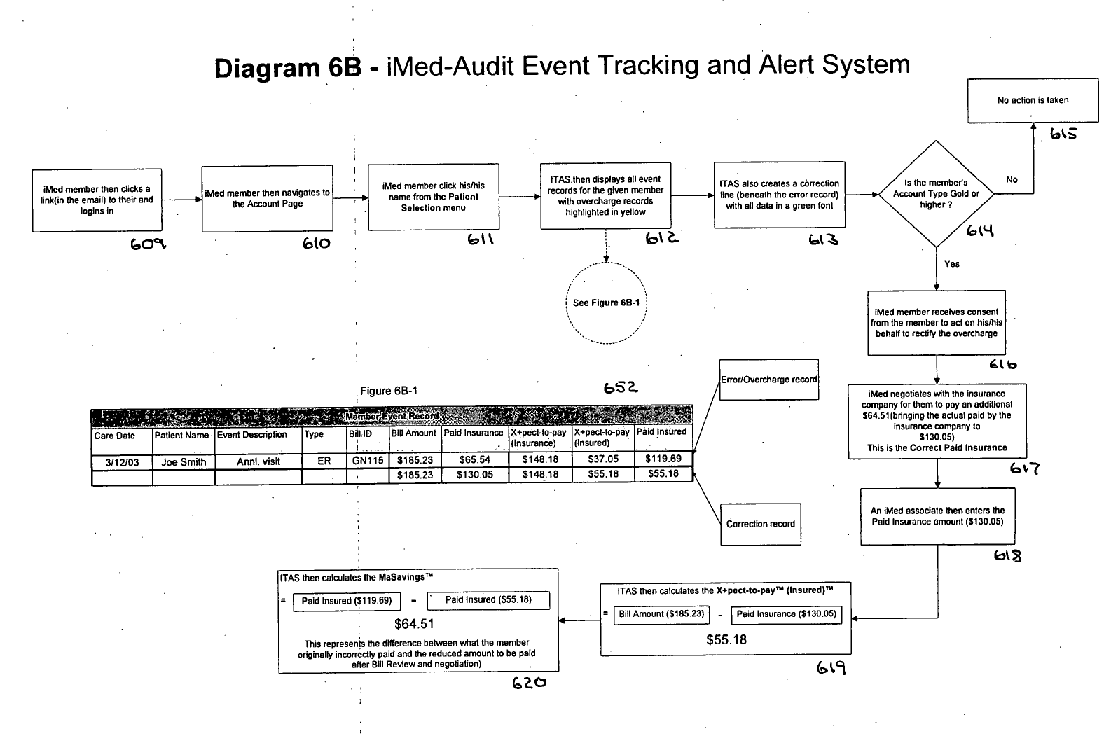

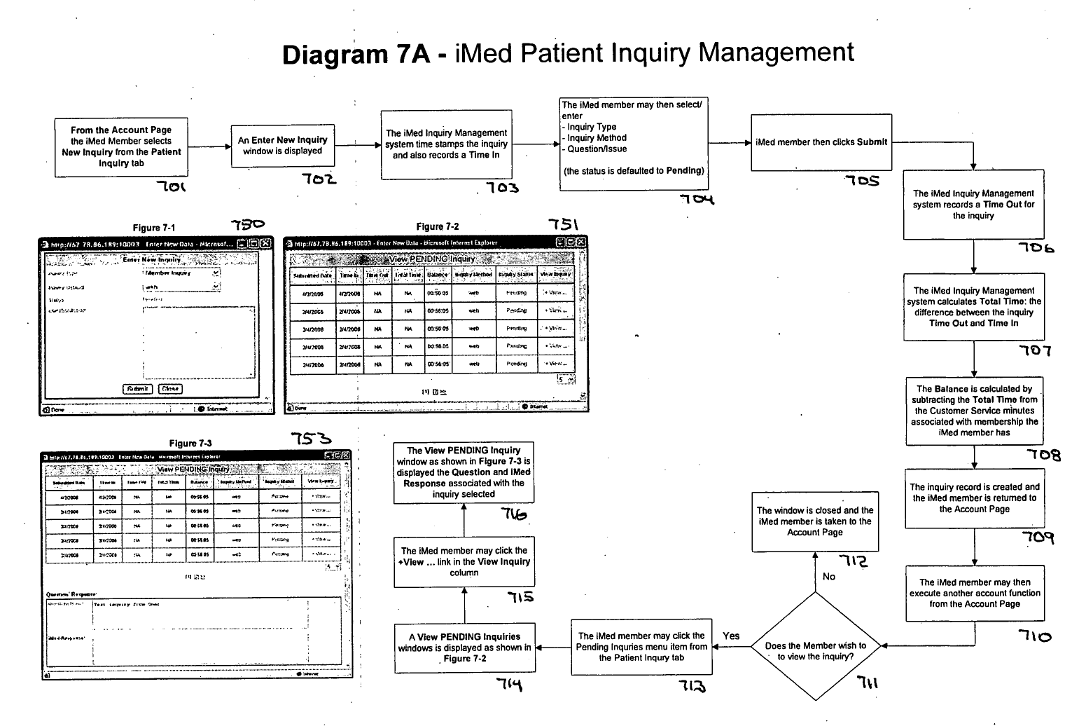

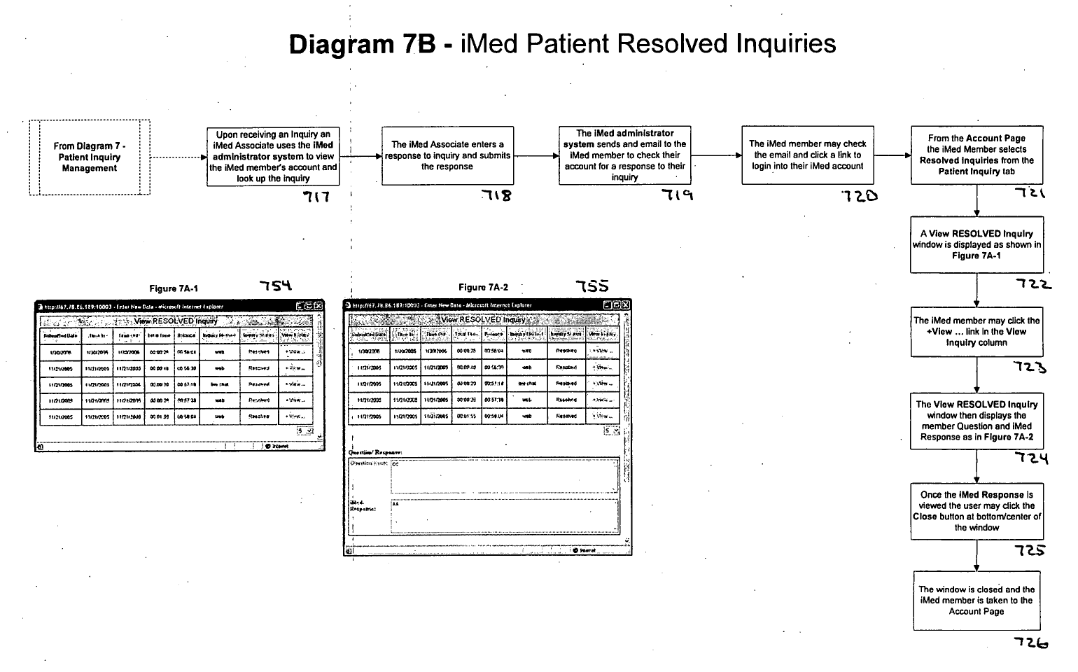

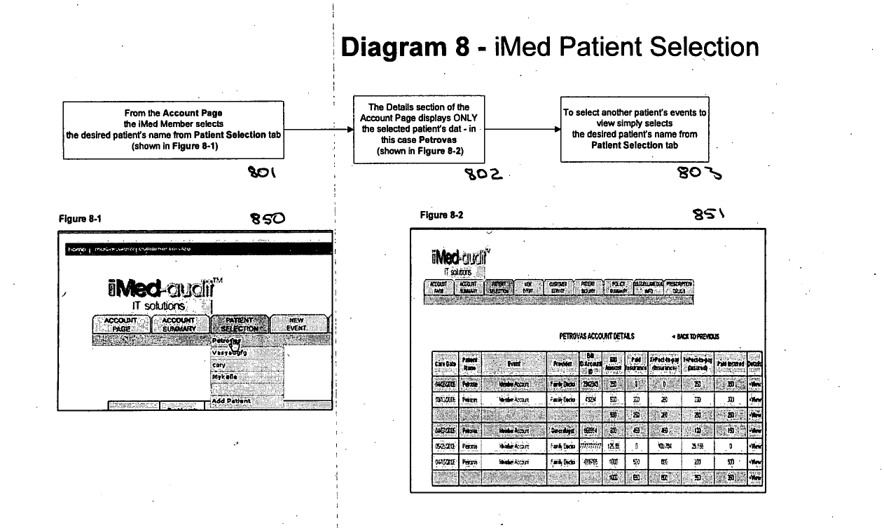

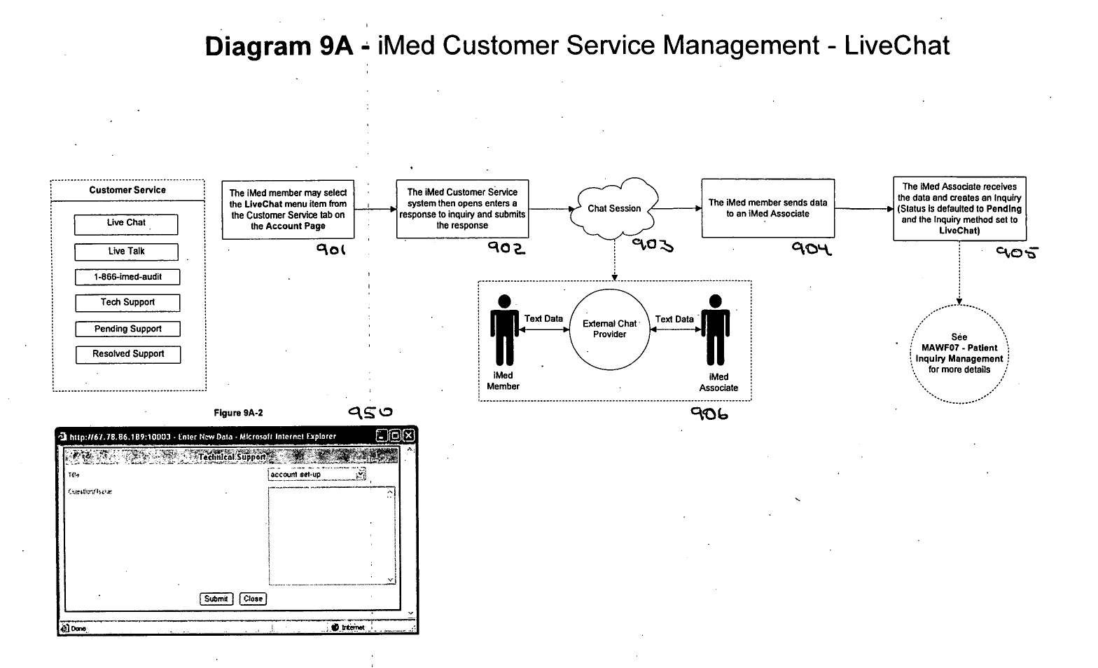

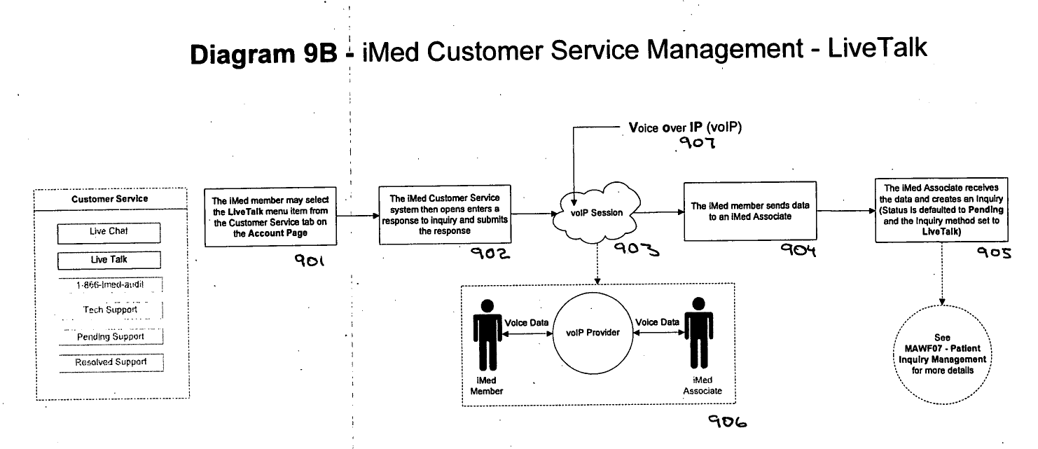

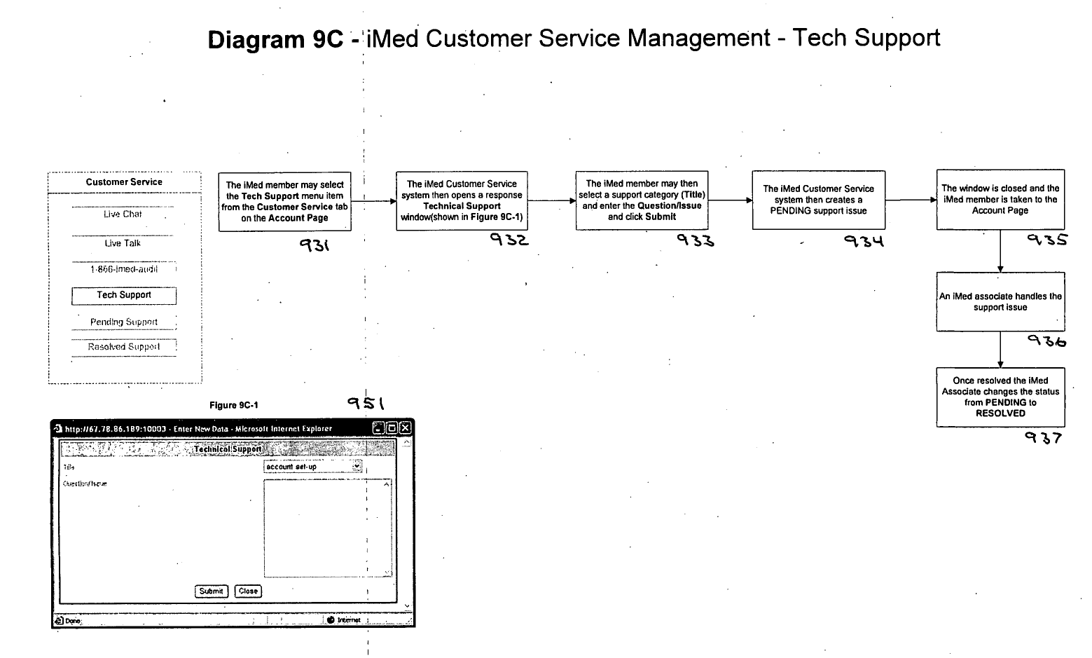

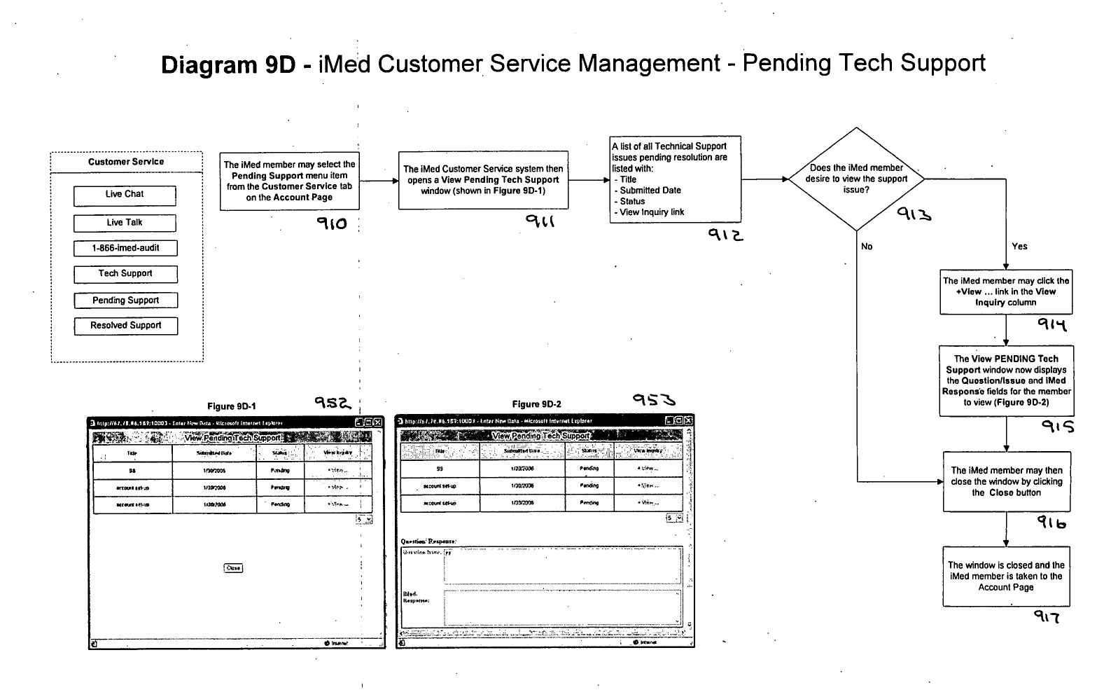

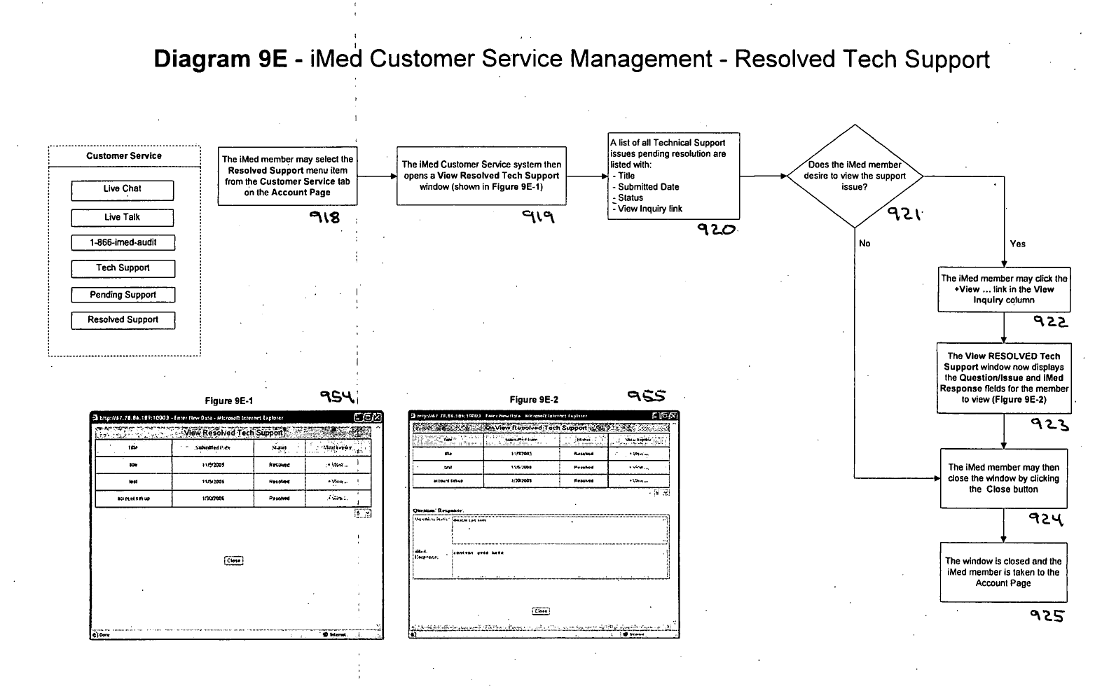

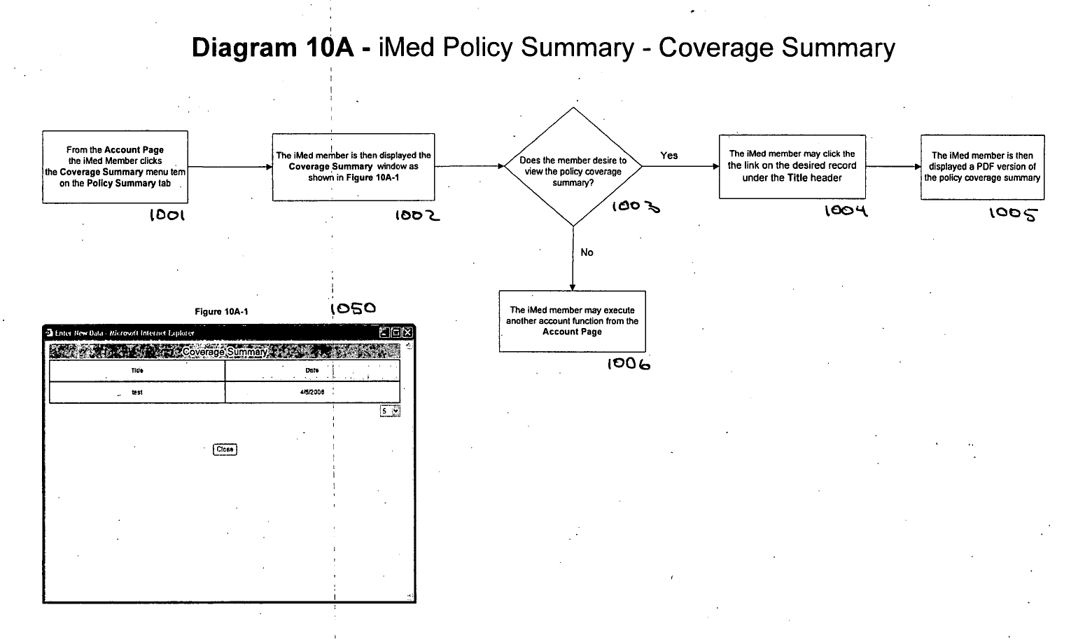

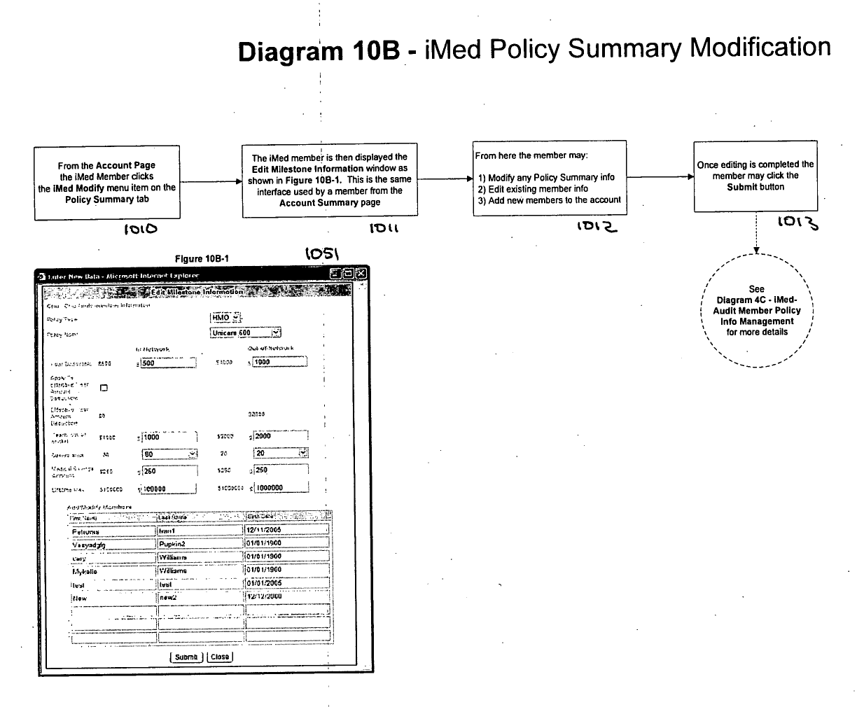

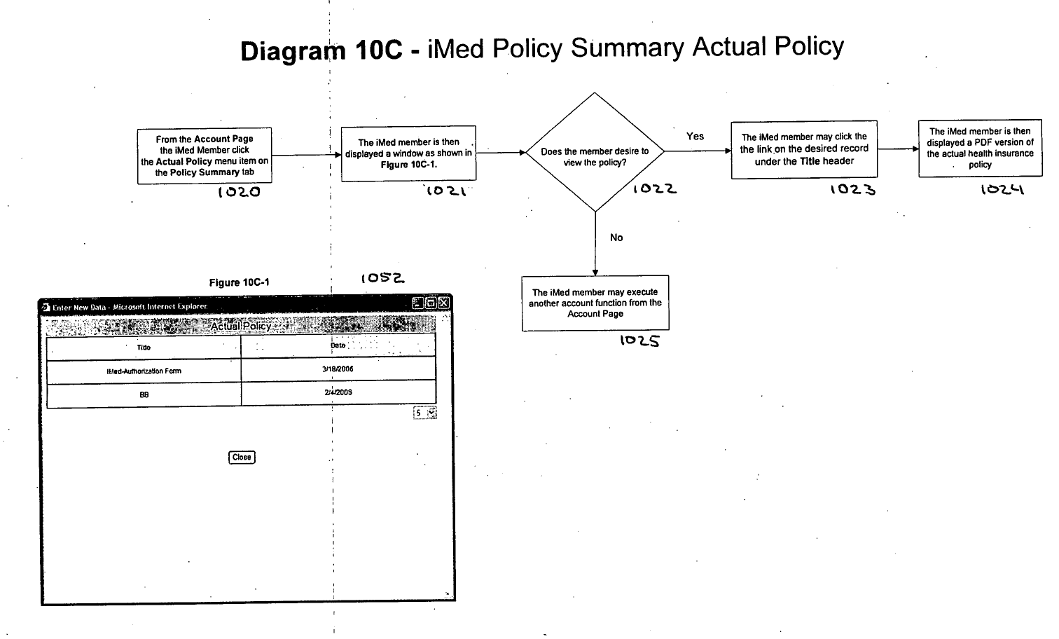

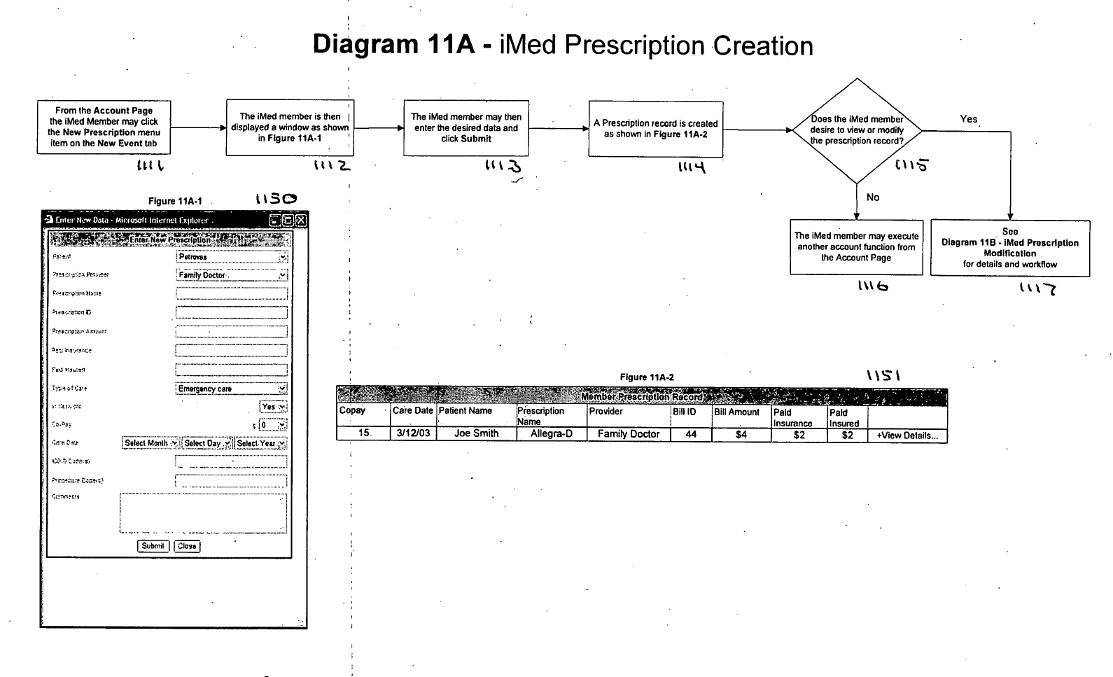

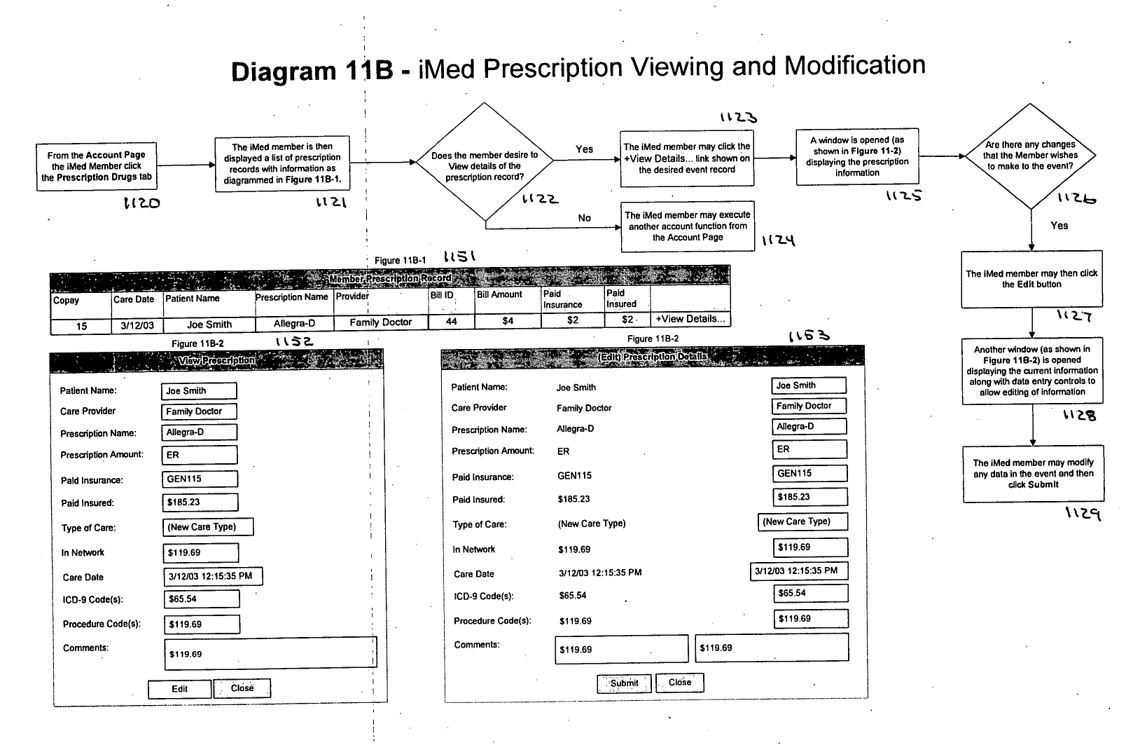

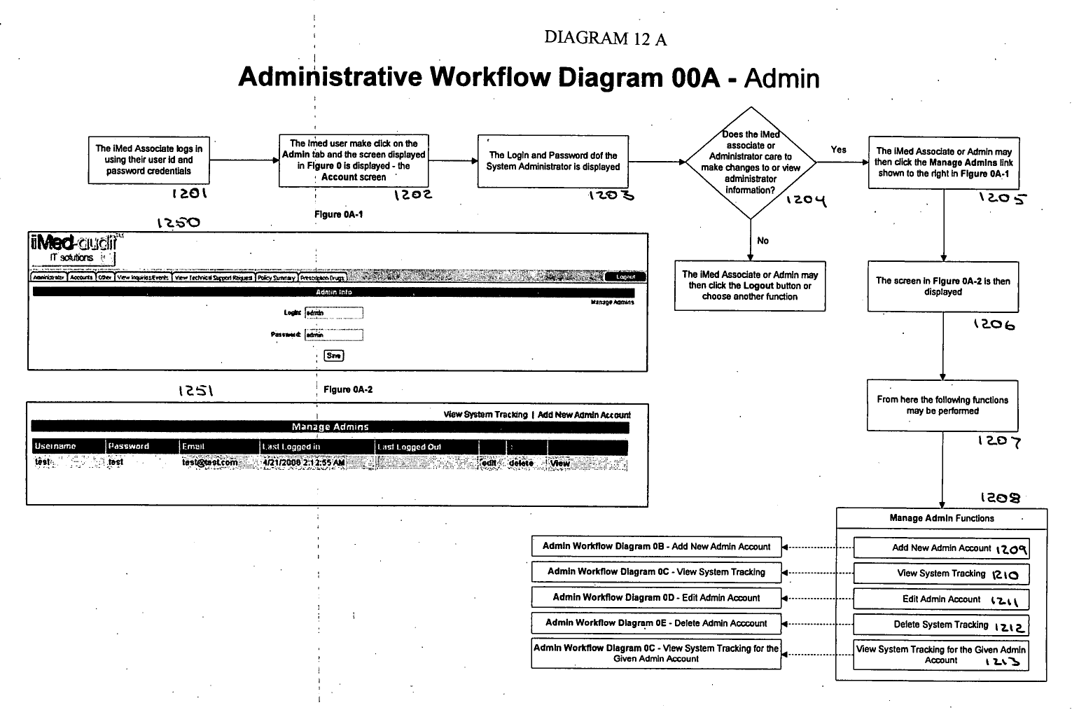

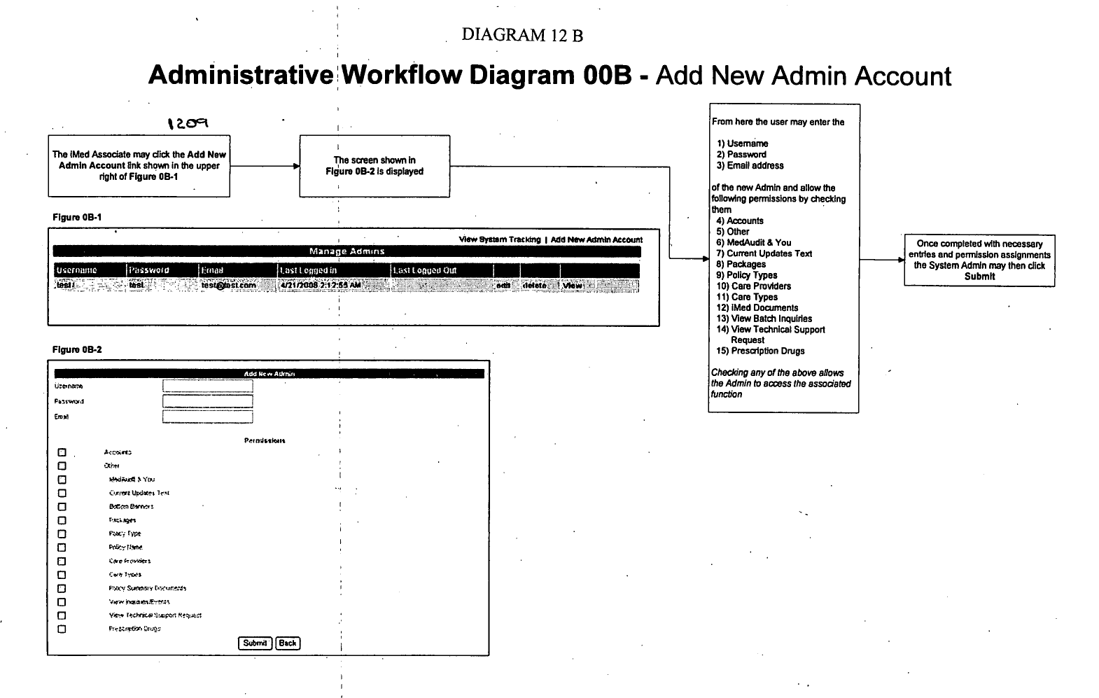

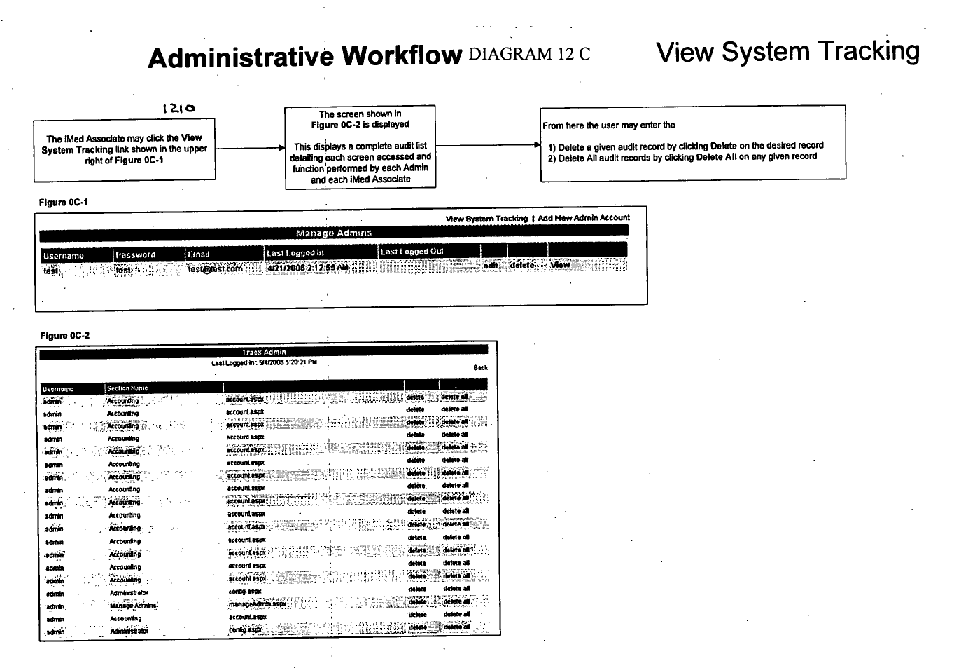

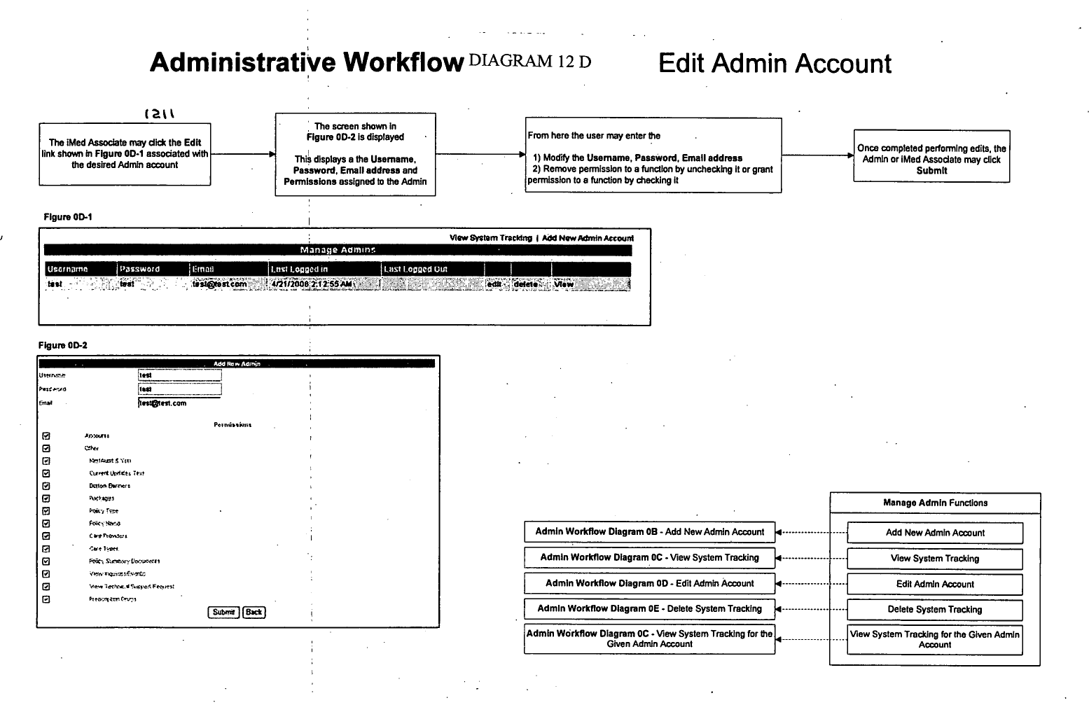

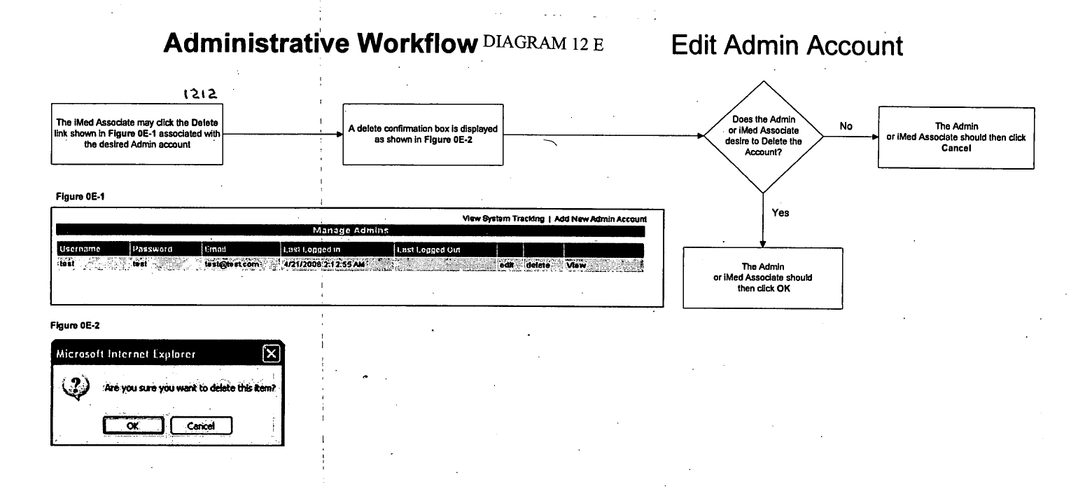

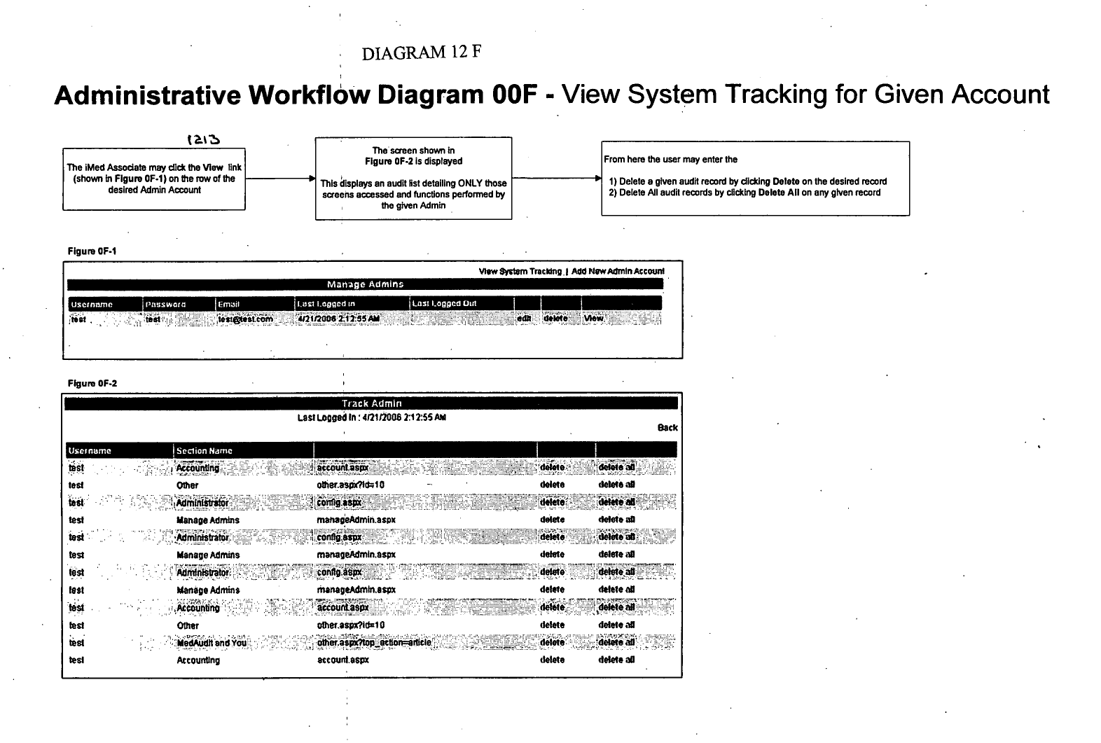

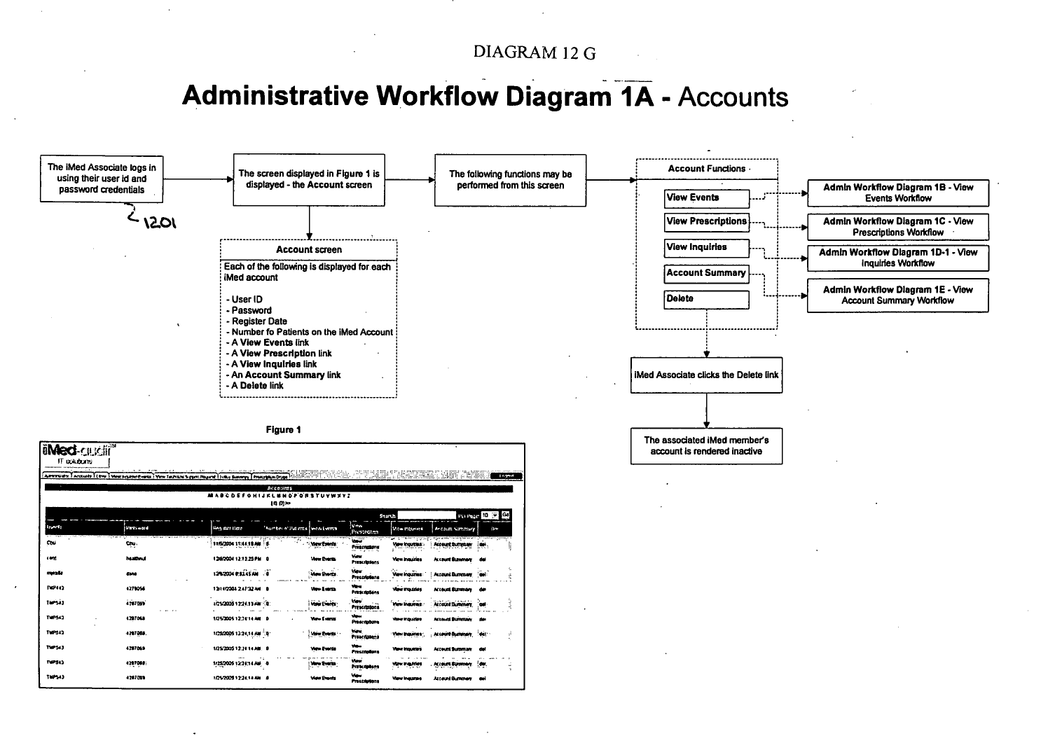

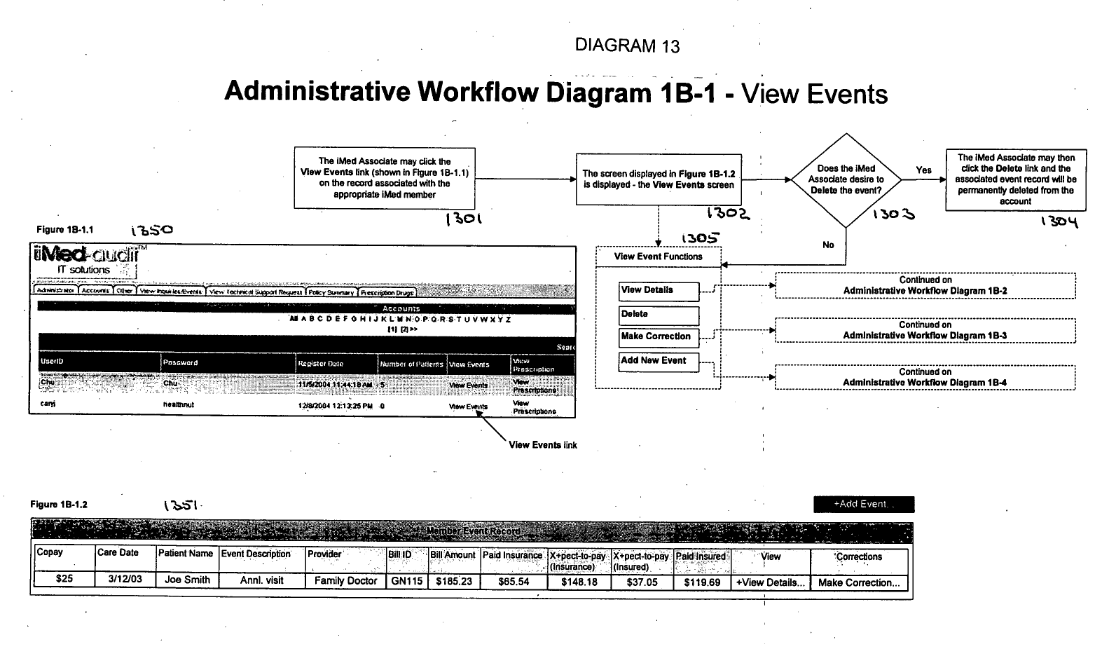

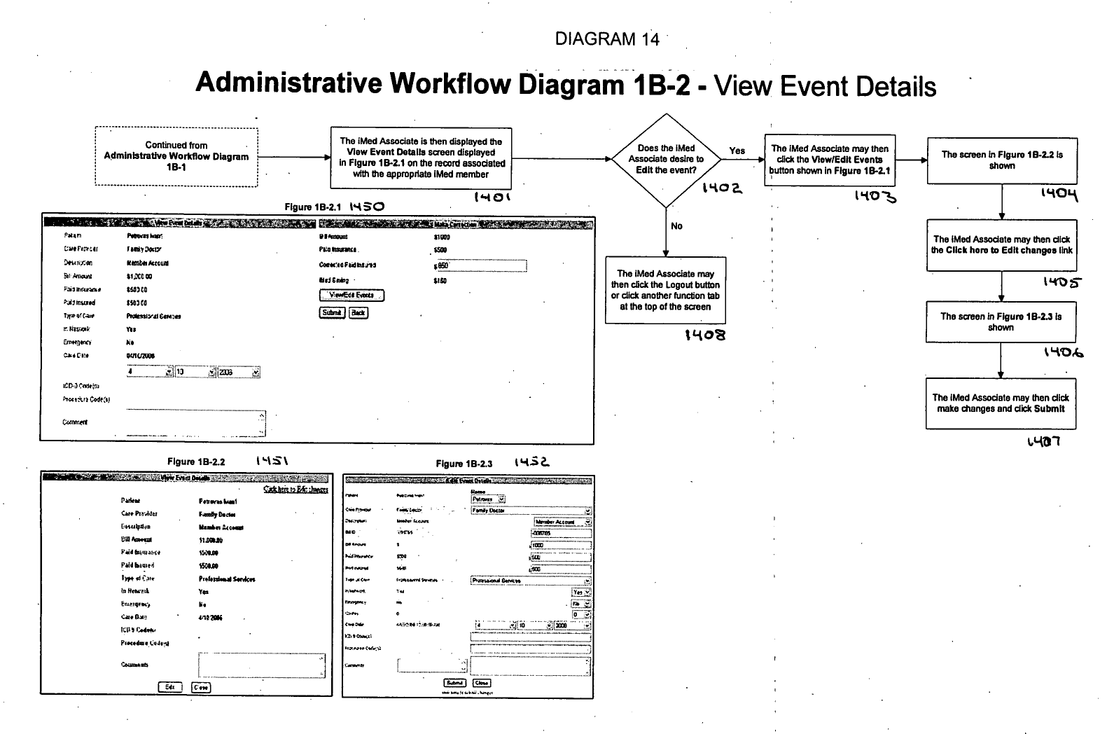

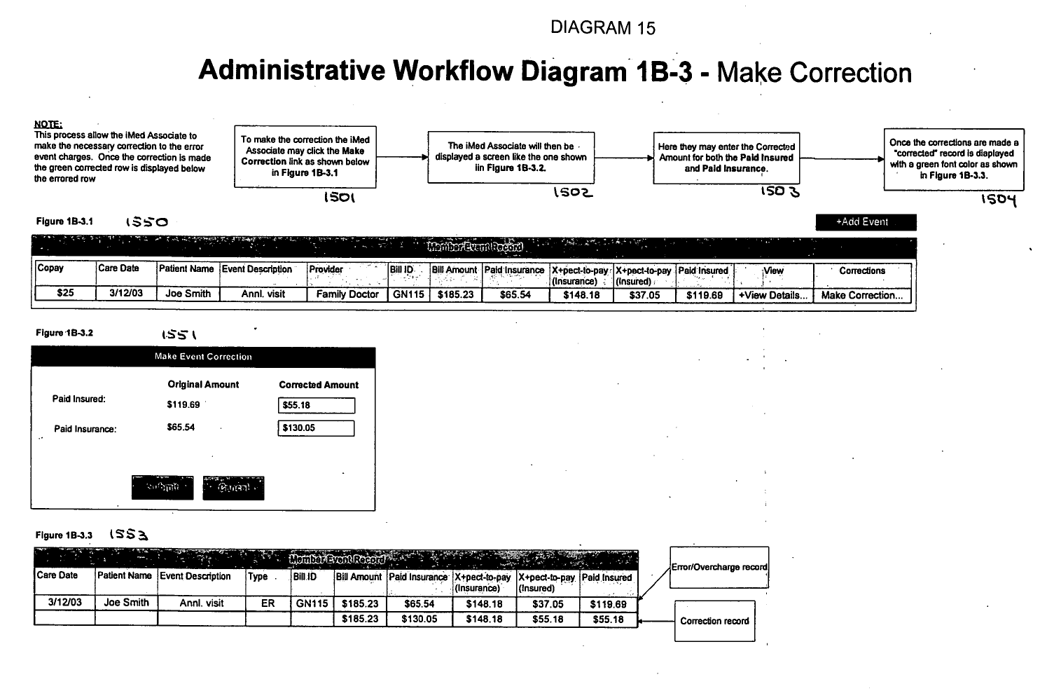

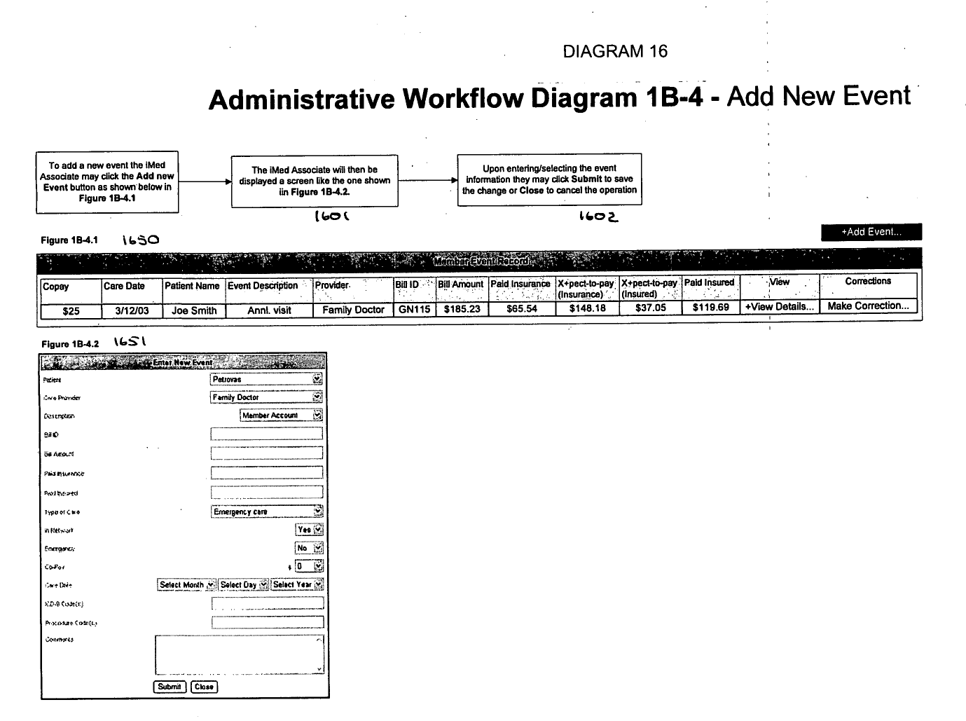

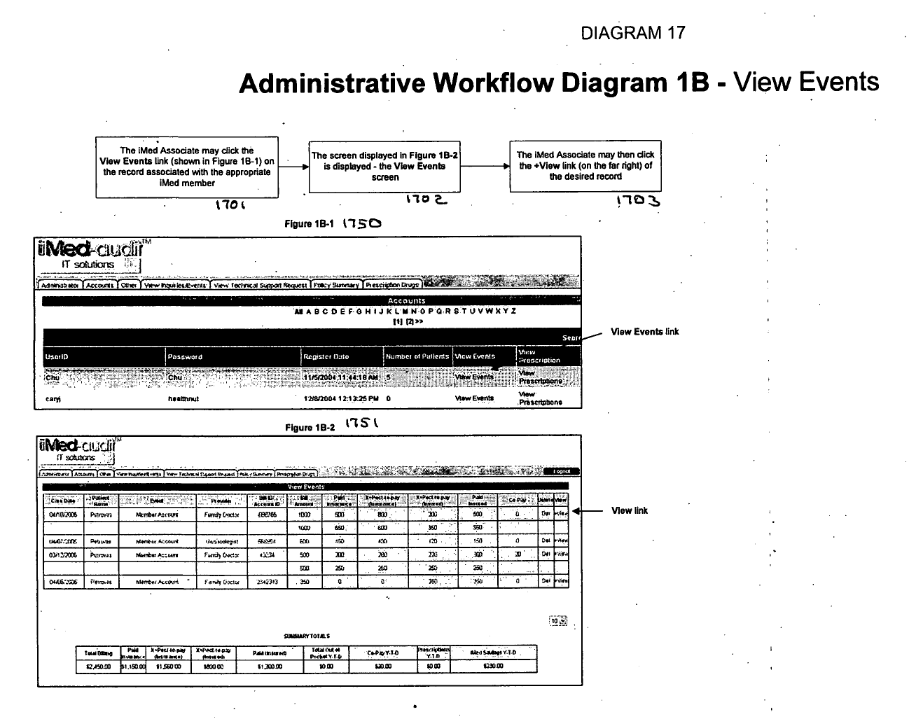

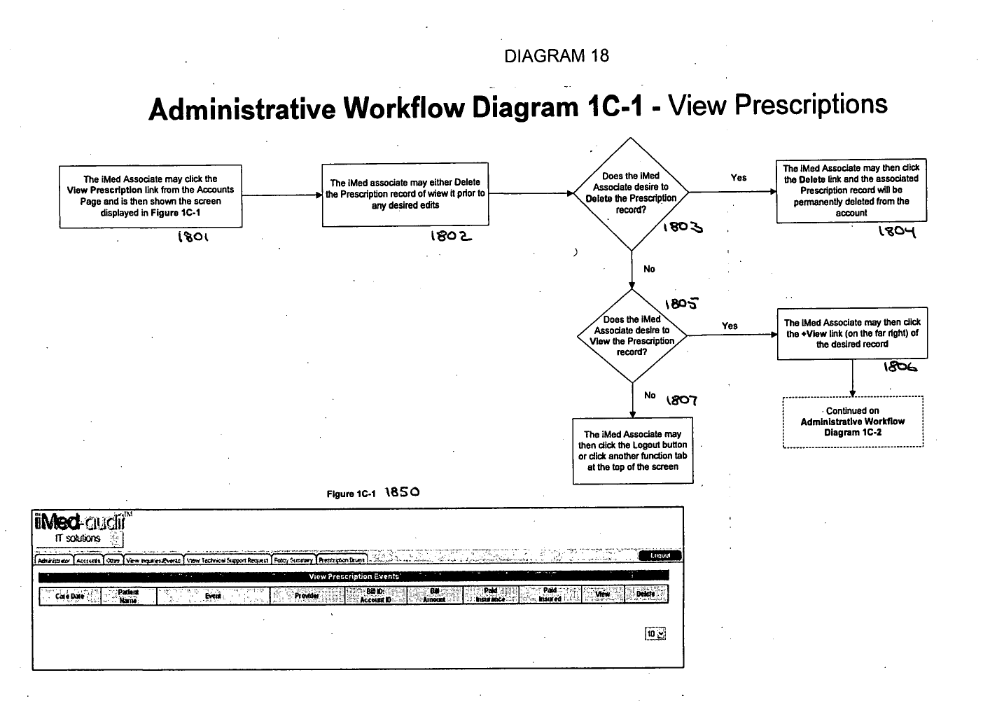

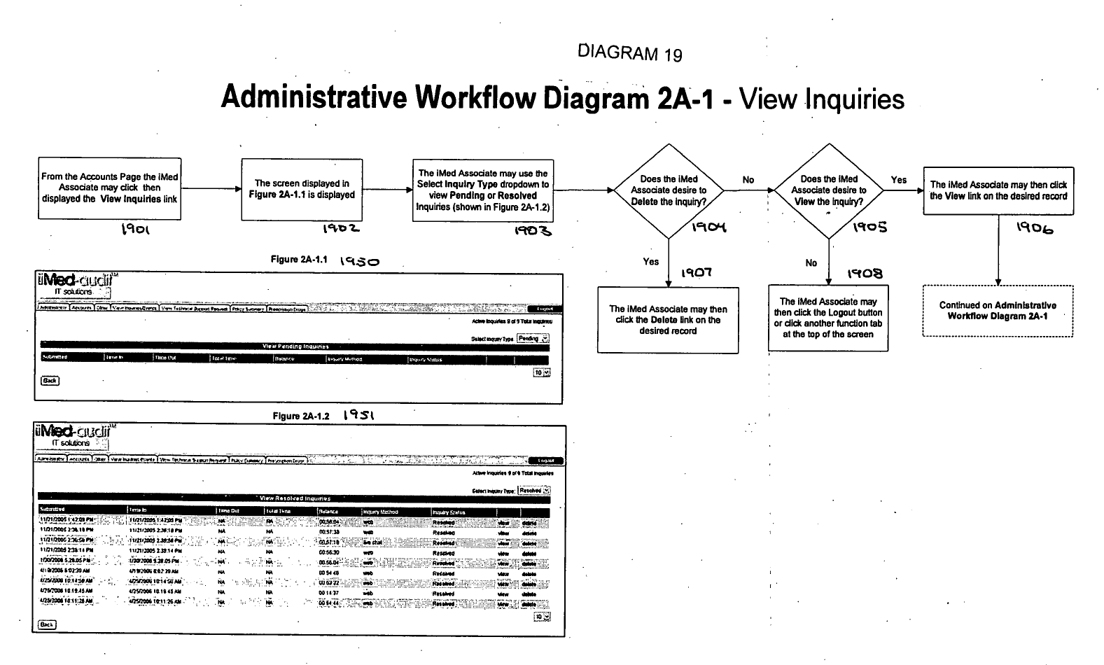

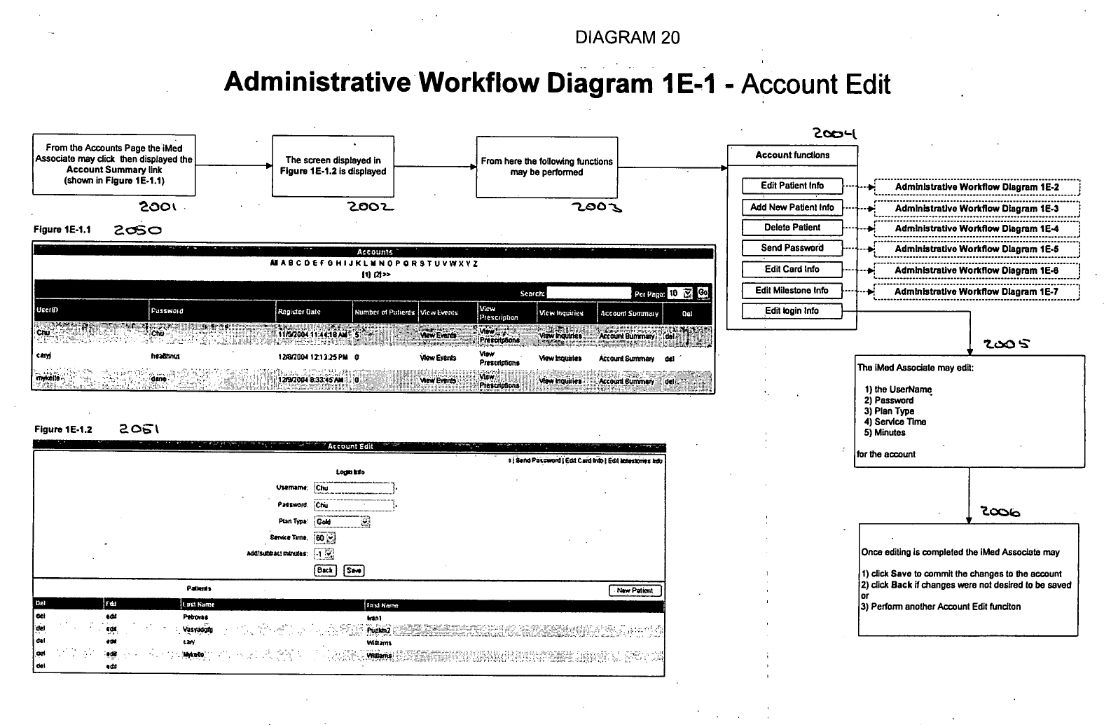

The inputted information may be displayed to the member in a form similar to FIG. 5-1 550. The invention evaluates the amount of the medical bill, the nature of services and location (office visit, emergency room, etc.) and other variables and computes what portion of the total bill should be paid by the insurer under the terms of the applicable policy (previously inputted by the member). The amount of the actual payment by the insurer is also displayed. A similar evaluation is made by the invention with respect to the payment made and expected to be made by the member.

Diagram 6A entitled “iMed-Audit Event Tracking and Alert System” illustrates an embodiment of the invention wherein the aspects of the evaluation discussed in the preceding paragraph are explained in greater detail. From the member furnished data of the event, the system creates a record 601 of variables including “care date”, “patient name”, “event description”, “provider” (i.e., health care provider), “bill ID” and “bill amount”. From this information and the details of the member insurance plan (previously imputed during “account creation”), the system evaluates the portion of the event bill that should be paid (“x+pect to pay”) by the insurer 602 and the co-pay obligation of the member 603. The system of the invention further evaluates 604 the actual payment amount to the calculated “x+pect to pay” amount and alerts the member to discrepant payment amounts. In other words, the system of the invention automatically checks or audits whether the insurer is meeting its contractual obligations to the member. In the example illustrated, the system has determined that the insured has under paid the obligation by $82.64.

In the embodiment illustrated, the system presents the member with the information via the Internet in a format similar to the presentation of FIG. 6A-1 650. The policy data can be summarized in a format similar to the presentation illustrated in FIG. 6A-2 651.

In the embodiment illustrated in Diagram 6A, the member may have selected a threshold level 605 for discrepant benefit payment performance that will trigger inquiry to the insurer. If the insured underpayment is below a specified and predetermined threshold, the system takes no further action 606. If, however, the insured underpayment is in excess of the threshold, 607, the member is alerted. In the embodiment illustrated, this alert is communicated by email. Further the system associate may be alerted 608 to the underpayment for follow-up inquiry to be made to the insured on behalf of the member.

Diagram 6B continues the process steps of the illustrated embodiment of the invention. The member receives the email alert 609 and may navigate to the account page 610 and click his/her name from the patient selection menu 611. The page is displayed showing all account activity 612. This may be presented to the member in a format similar to FIG. 6B-1 652. In the embodiment illustrated, the discrepant (overcharges) payments are highlighted in yellow 653. The system may also created a correction line 613 highlighting adjustments achieved by associate inquiry to the insurer. Note that the occurrence of an inquiry activity may be a function of the membership level purchased by the member 614, 615. (See step 204 in Diagram 2.)

If the member has purchased the requisite membership level, the member is prompted 616 to provide consent and authorization for the system associated to make inquiry on behalf of the member to the insured concerning the discrepant payment. With the requisite authorization, the event, services, policy obligations, event charges and payments made, etc. are reviewed with the insured 617.

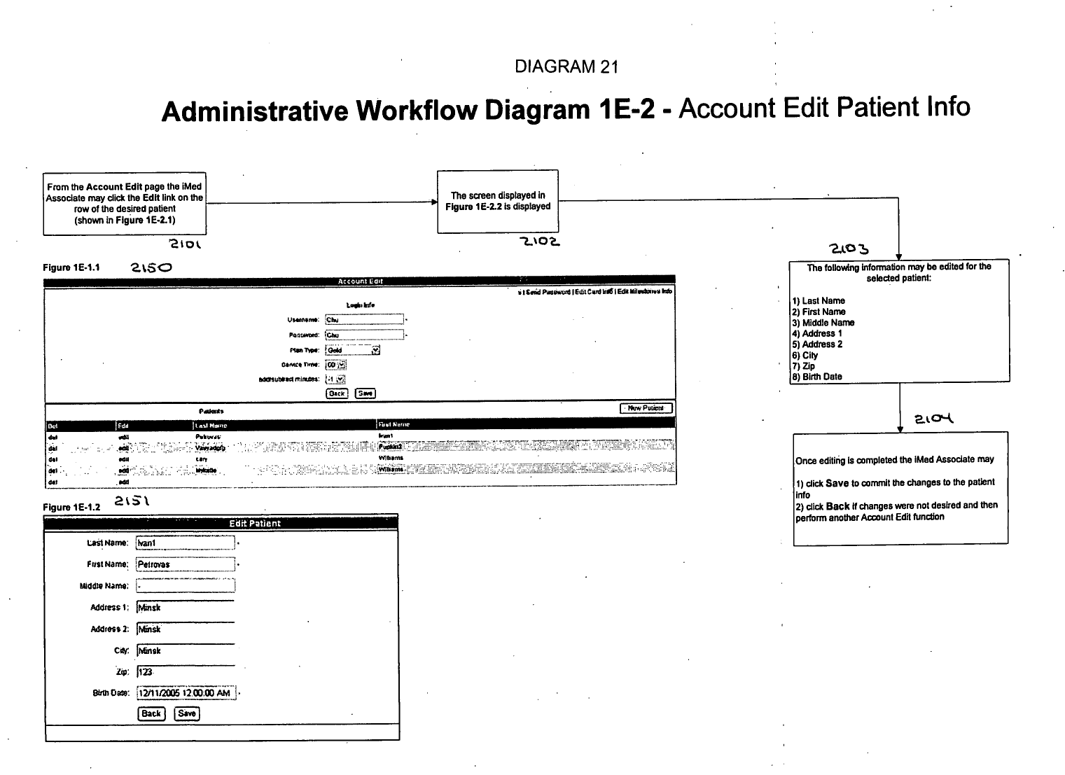

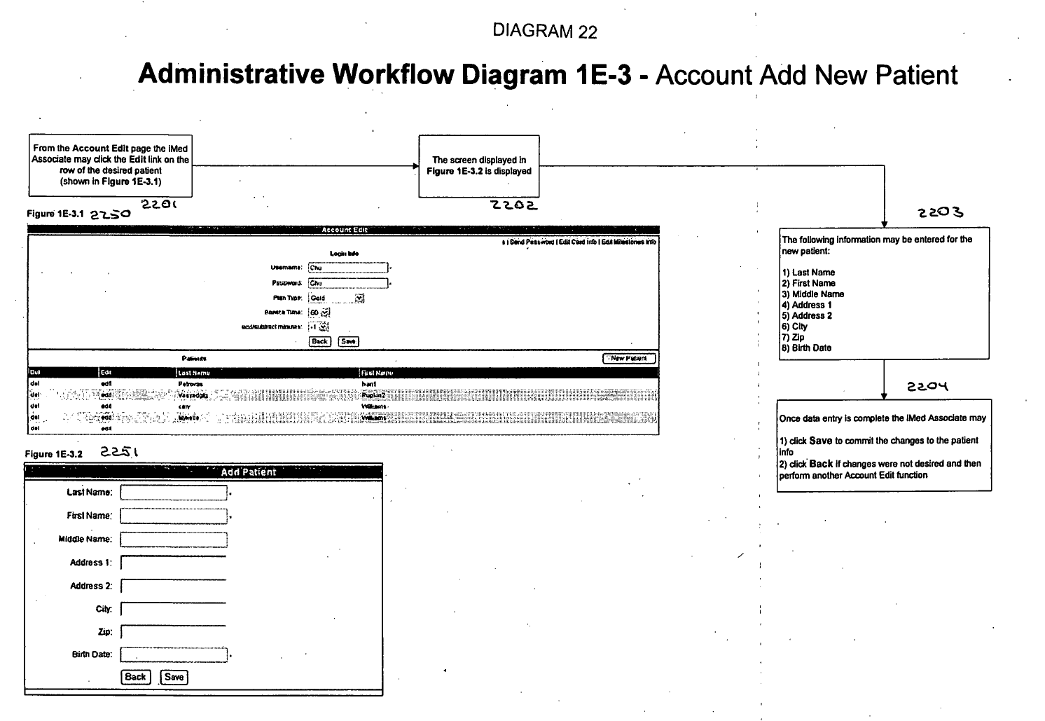

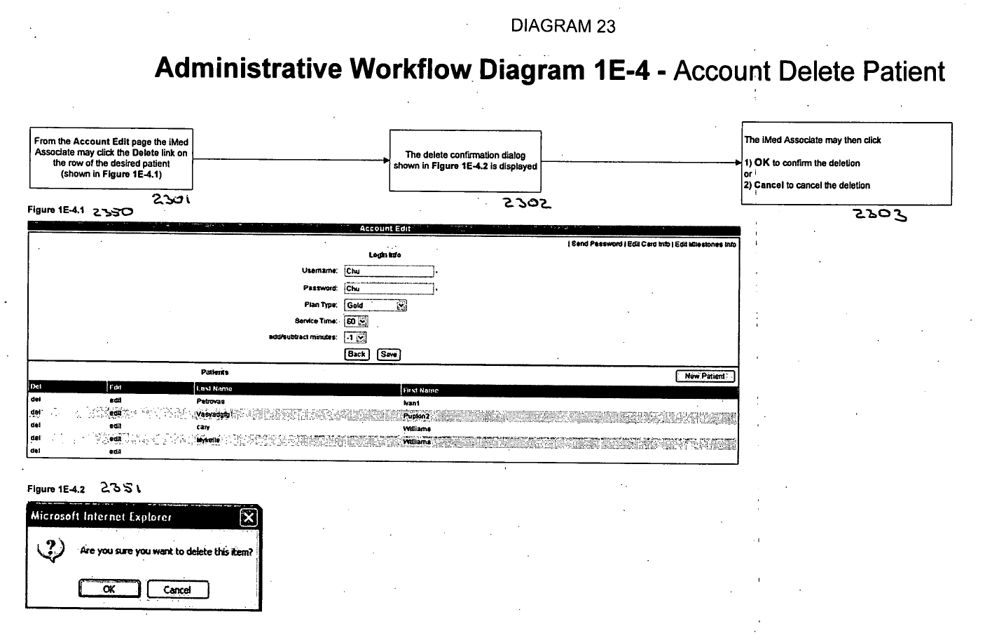

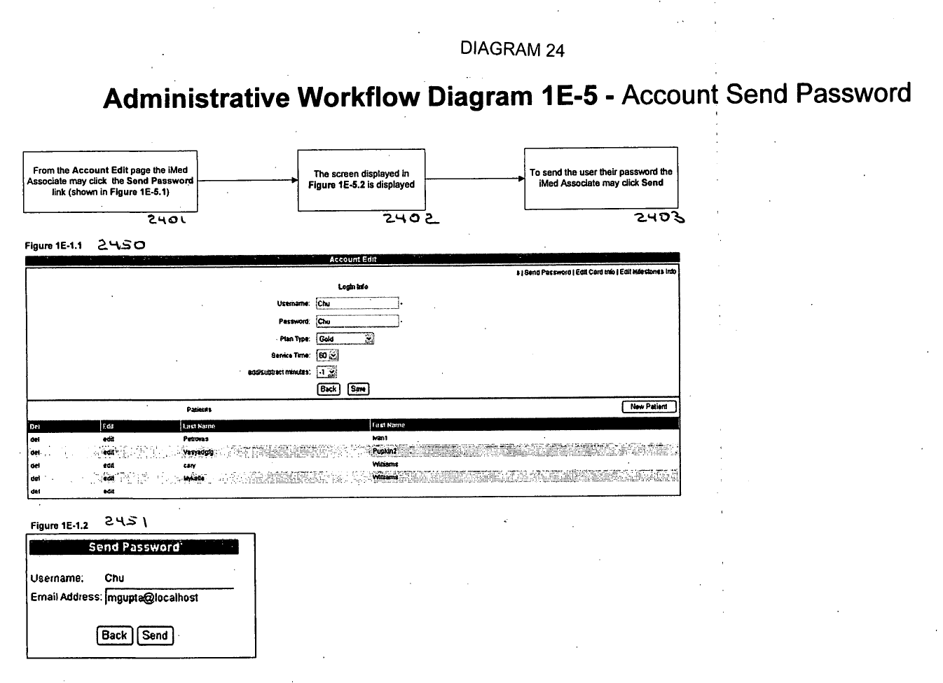

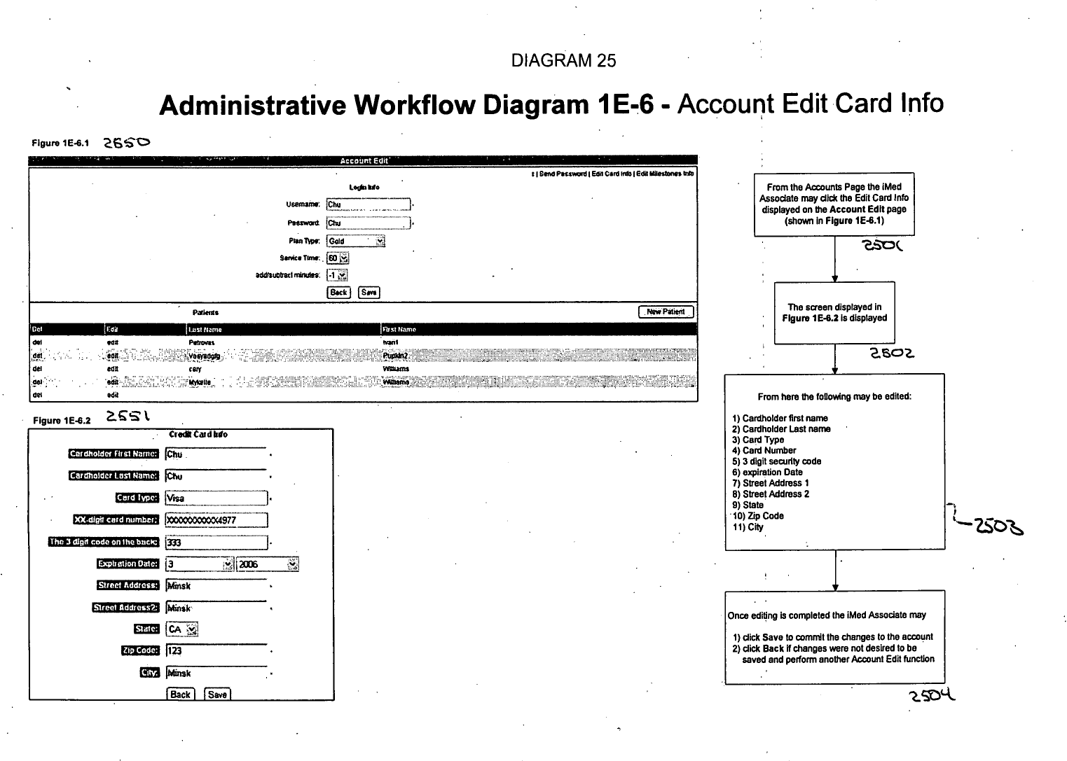

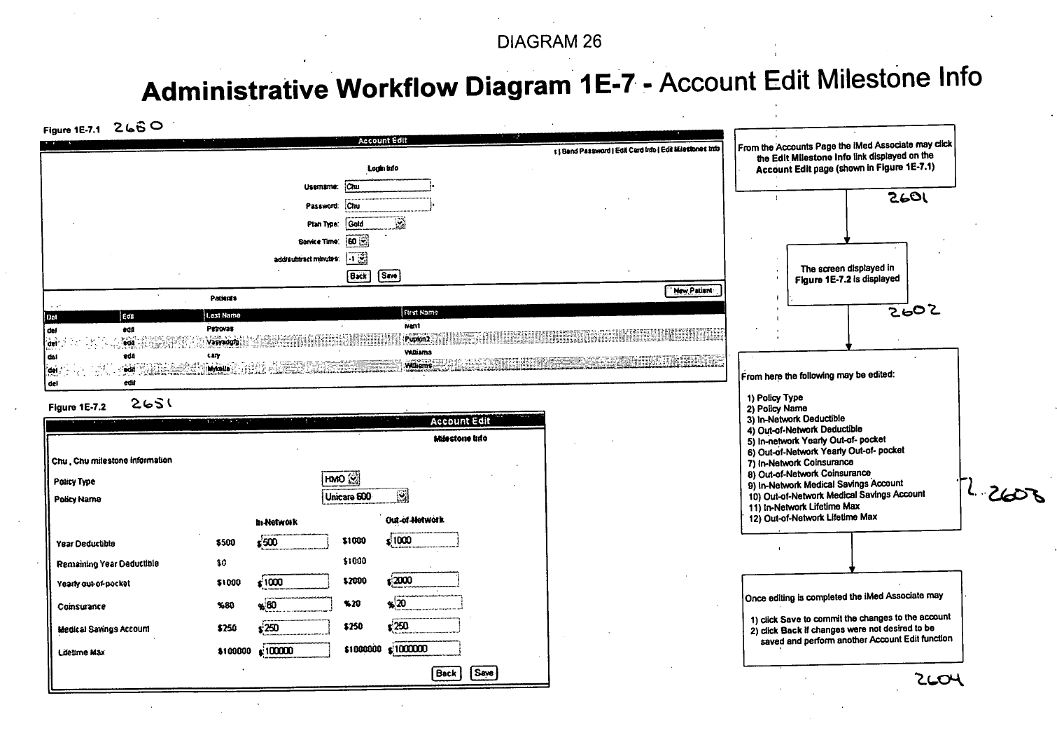

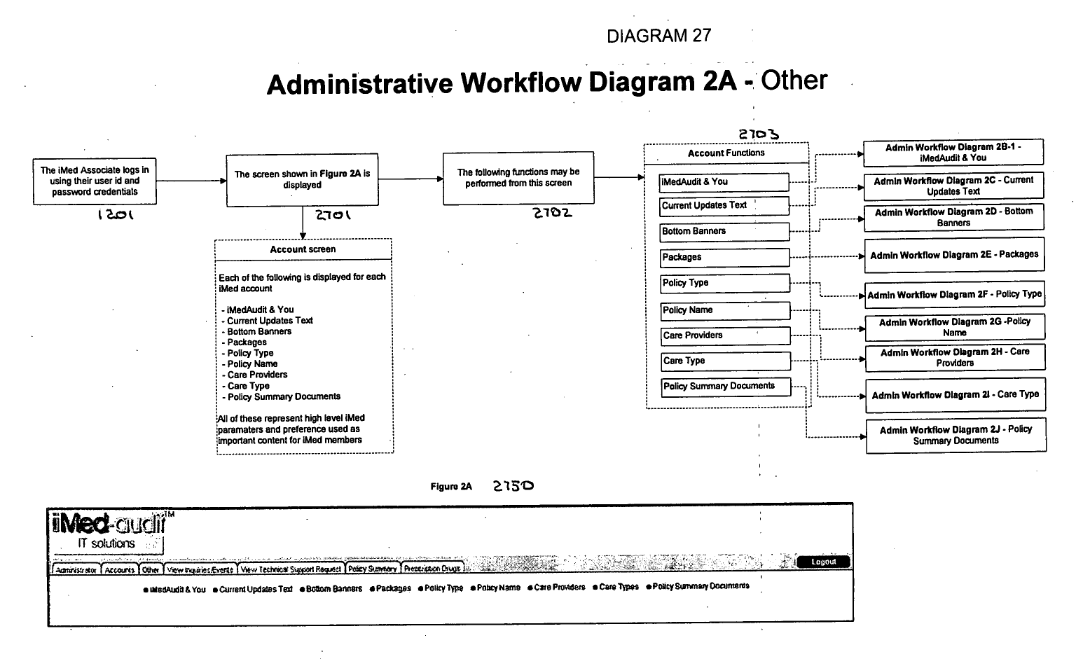

The system associate, possessing knowledge of the event, insurance policy provisions, service provider practices, dedicated time to communicate with the insurer, is positioned to productively make inquiry to the insurer regarding the apparent discrepant payment and achieve additional payment consistent with policy payment obligations. It will be further appreciated that the system associate has access to the relevant records and information inputted by the member in machine readable format. The information is readily accessible from electronic databases. It will be further appreciated that the system associate has access to the member for supplemental information via email or other electronic communication mechanism. Similarly, the system associate may have access to the health care provider (as authorized by the member) in order to obtain additional information regarding services provided and related documentation necessary to obtain full payment from the insurer. In this activity, the system associate may serve as an ombudsman, i.e., investigate complaints, report findings and mediate fair settlements. (Reference is made to Diagram 5, step 501 and Diagram 7B step 724 and FIG. 7-3)

Comments or notations made in the inquiry step 617 may also be coded or indexed for retrieval or storage for later customer service or ombudsman fact gathering or mediation.

The additional insurance payment is recorded 618 and the revised payment evaluated to the “x+pect to pay” amount 619. The member is notified of the savings achieved by the system 620, 654.

Diagrams 7A and 7B illustrated embodiments for member inquiry to the system regarding payment issues, insurance coverage issues or technical questions concerning accessing member account records. For example, a member may inquire of MRI coverage under their insurance contract. A member may also make inquiry regarding payment of a deductible from their HSA account.

The process step again commences 701 from the account summary page with link from the account function via the account page. (See Diagram 4E) The member selects “patient inquiry” tab. The member is prompted to “enter new inquiry” window 702 and the system time stamps the inquiry and “time in” 703.

It will be appreciated that in one embodiment of the invention, the member has paid for limited minutes of system time in which inquiries may be made and responses provided. It will be further appreciated that the member may optionally purchase additional time or subscribe to a plan with unlimited inquiry time.

The member enters the question which may be categorized by type and method. 704 and the inquiry is submitted 705. (See FIG. 7-1 750) The “time out” 706 is mark and elapsed time calculated 707. The new balance of available time is calculated 708. The inquiry recorded is recorded (defaulted to pending inquiry) and the member may be returned to the account page 709. The member may also view the pending inquiry by selecting the “patient inquiry” tab 713 and viewing the “pending inquiries” 714. The member may be prompted to a screen illustrated by example to FIG. 7-2 751. The member may optionally click the “+View” link in the “view inquiry” column 715 and be presented with the response screen illustrated by FIG. 7-3 753.

Diagram 7B illustrates an embodiment for the system associate to handle a member inquiry. Upon receiving the inquiry the associate uses the system to view the member's account and look up the inquiry 717. The associate enters the appropriate response to the inquiry and submits the response 718. The system administrator sends an email to the member to check their account for a response to the inquiry 719. The member may check the email and click a link to login into their account 720. Again, commencing from the account page, the member may select “resolved inquiries” from the “patient inquiry” tab 721. The member may be presented 722 with the window or screen “resolved inquiry”, an example of which is displayed as FIG. 7A-1 754. The member may click the “+view” of the “view inquiry” column 723 and the member's question and associate's response is displayed 724 as illustrated in FIG. 7A-2 755. The member may close the screen 725 and be returned to the account page 726.

Diagram 8 illustrates selection of an individual member from the account page and accessible detail.

Diagram 9A entitled “iMed Customer Service Management—Live Chat” illustrates an additional embodiment for customer service 901 again commencing from the account page link of the account summary page. The inquiry is handled similar to the patient inquiry management protocol illustrated in Diagrams 7A and 7B discussed above. The associate receives the data and creates an inquiry 905. Status is defaulted to pending and the inquiry method set to Live Chat.

Diagram 9B illustrates the ability of the member to use Voice of internet protocol to communicate with the system and administrators.

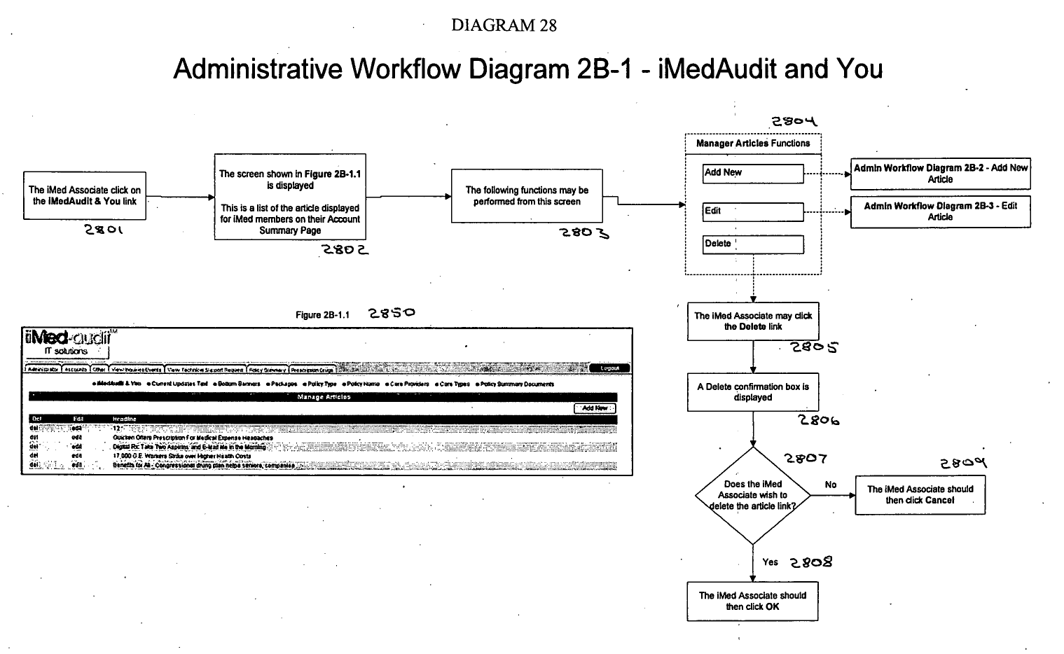

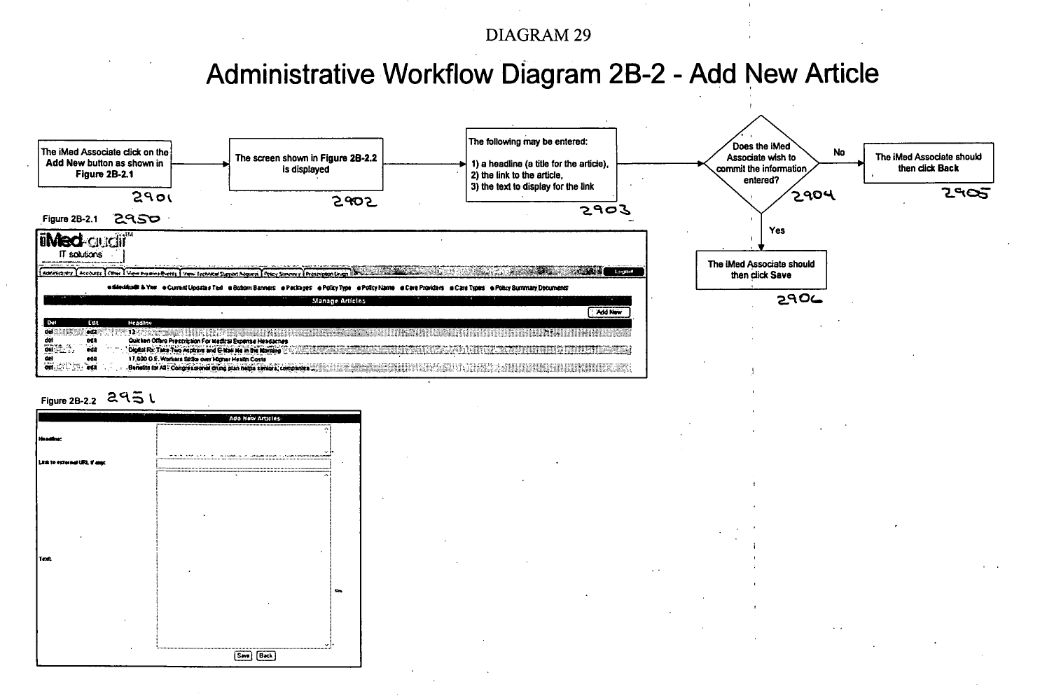

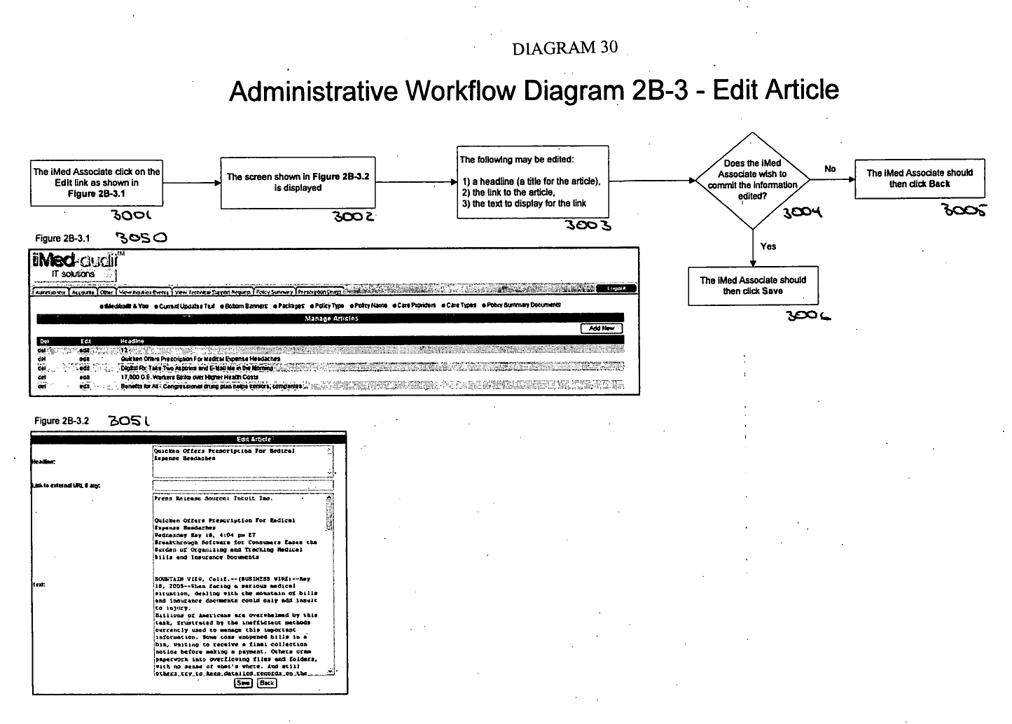

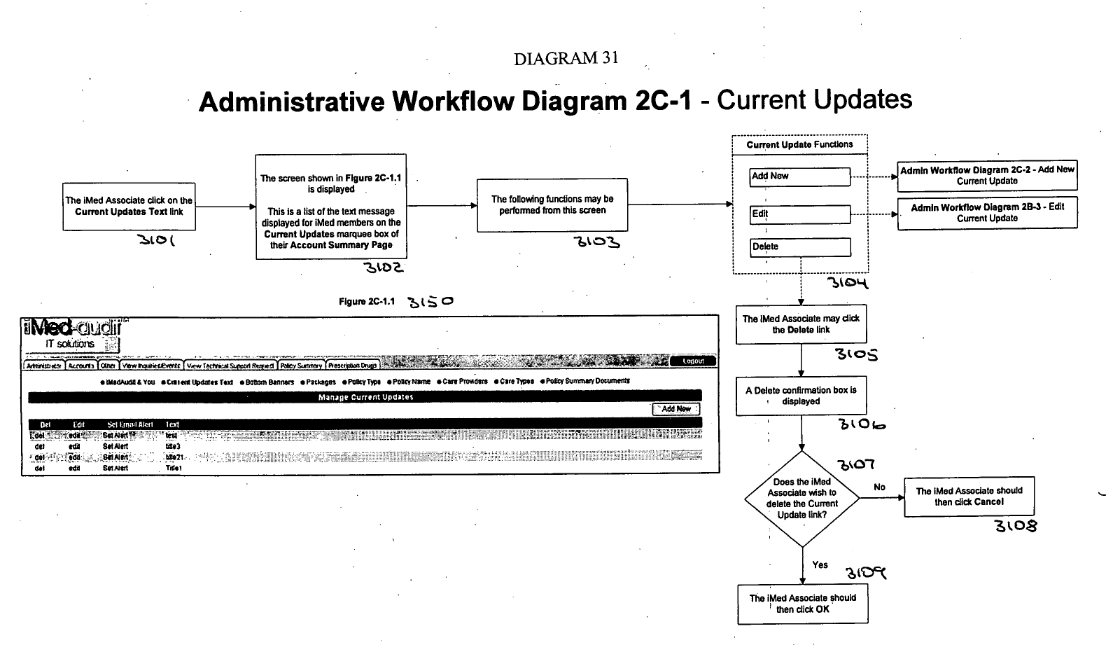

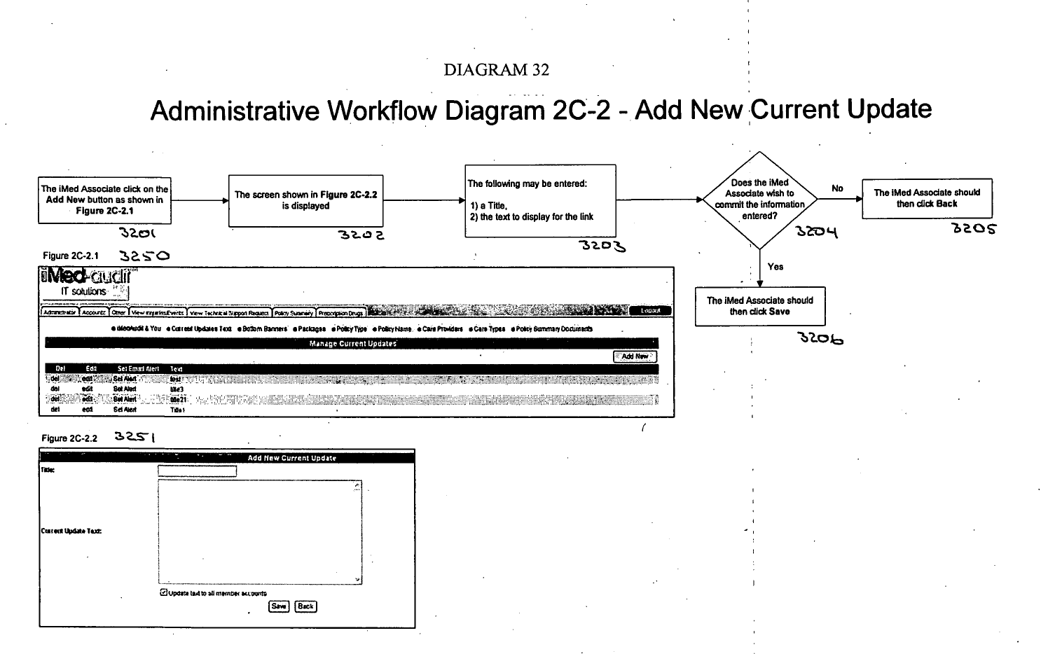

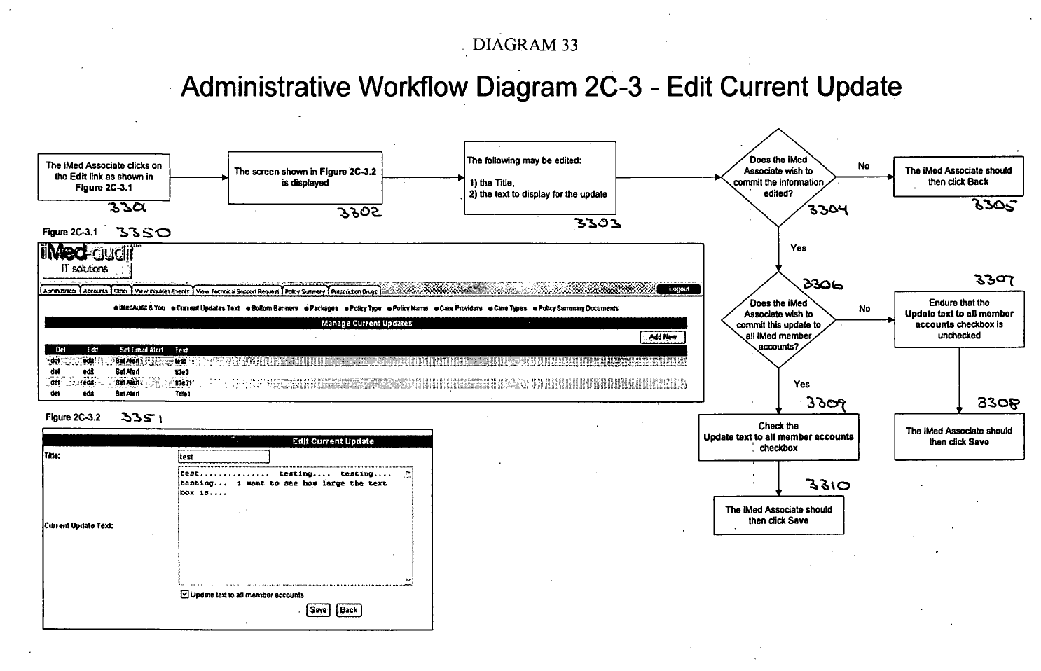

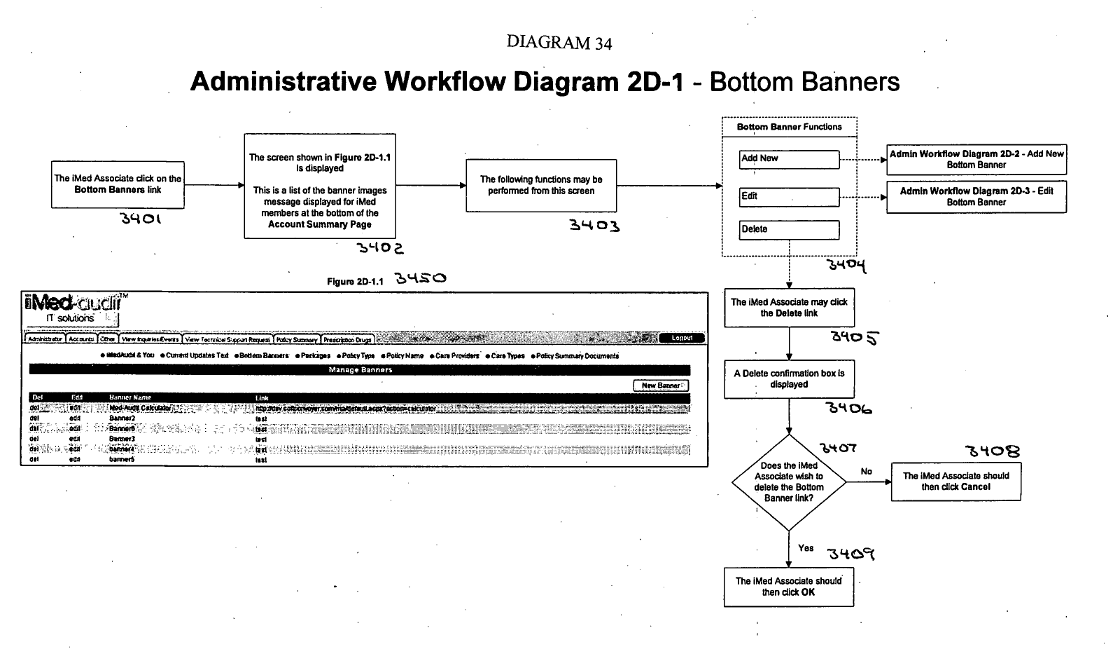

Diagrams 9C, 9D and 9E illustrate management of member technical support issues and resolution. Again, the sequence is illustrated as beginning from the account summary page. The member may open a technical support window as shown in FIG. 9C-1 951. The member may select a support category and enter a question or issue 932, 933. The inquiry may be submitted 934 and, in response, the system customer service system creates a pending support issue. The window is closed and the member is returned to the account page 935. The technical support question is handled and status is changed from pending to resolved. The member may be informed of resolution of the technical issue by email. In Diagram 9D, the member is provided the option of monitoring pending technical support inquiries 910. In Diagram 9E may review the resolved technical support issues 918. The member may be presented 919 with the resolved technical support page FIG. 9E-1 954. The member may review 922 the resolved technical support page 923 presented as FIG. 9E-2 955 containing the issues and system resolutions. The member may close the page 924 and be returned to the account page 925.

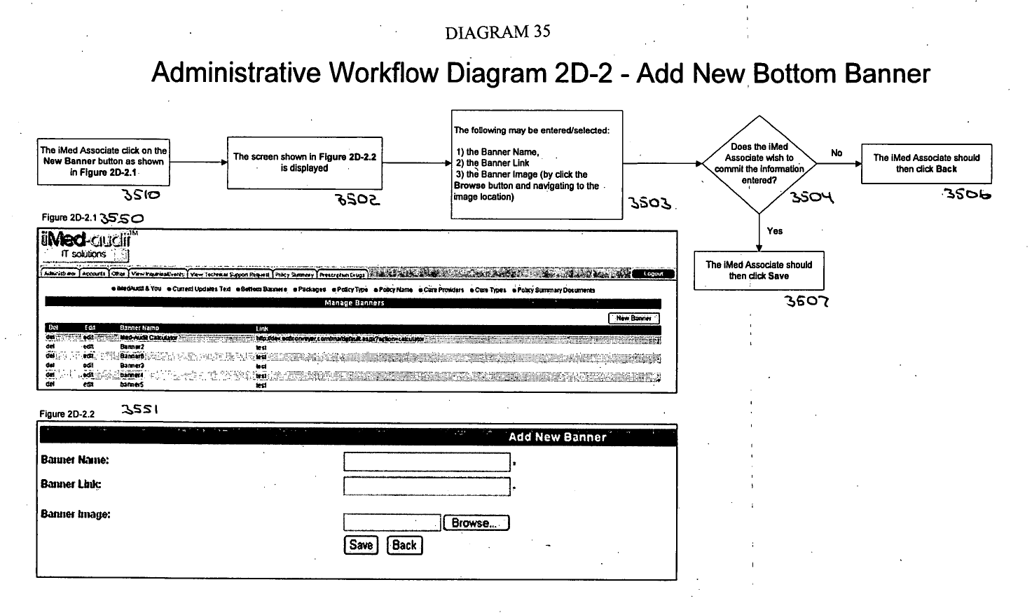

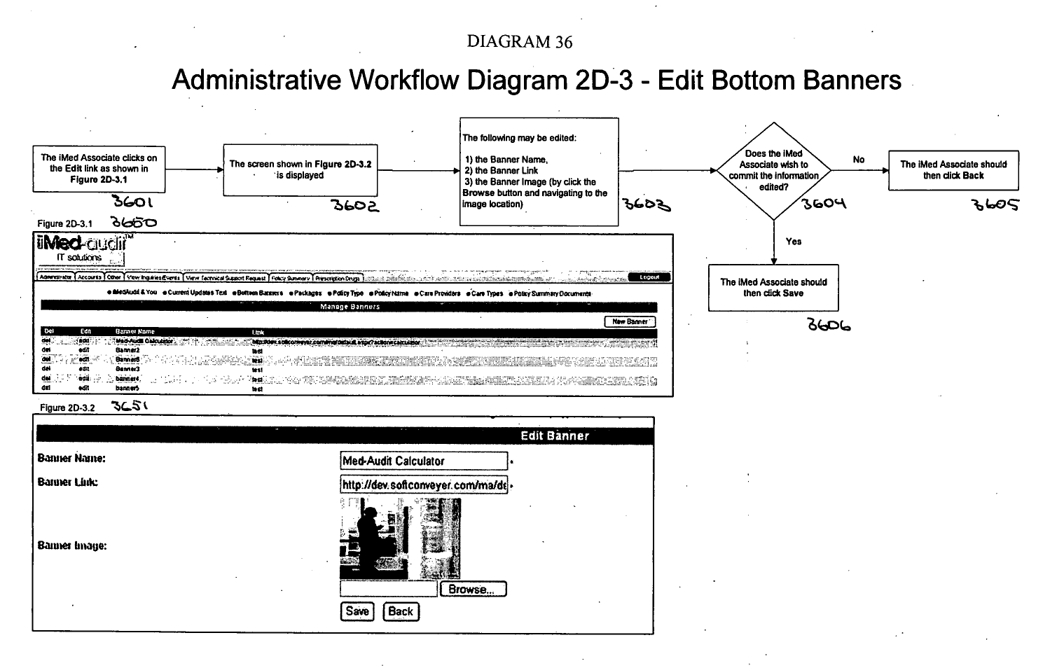

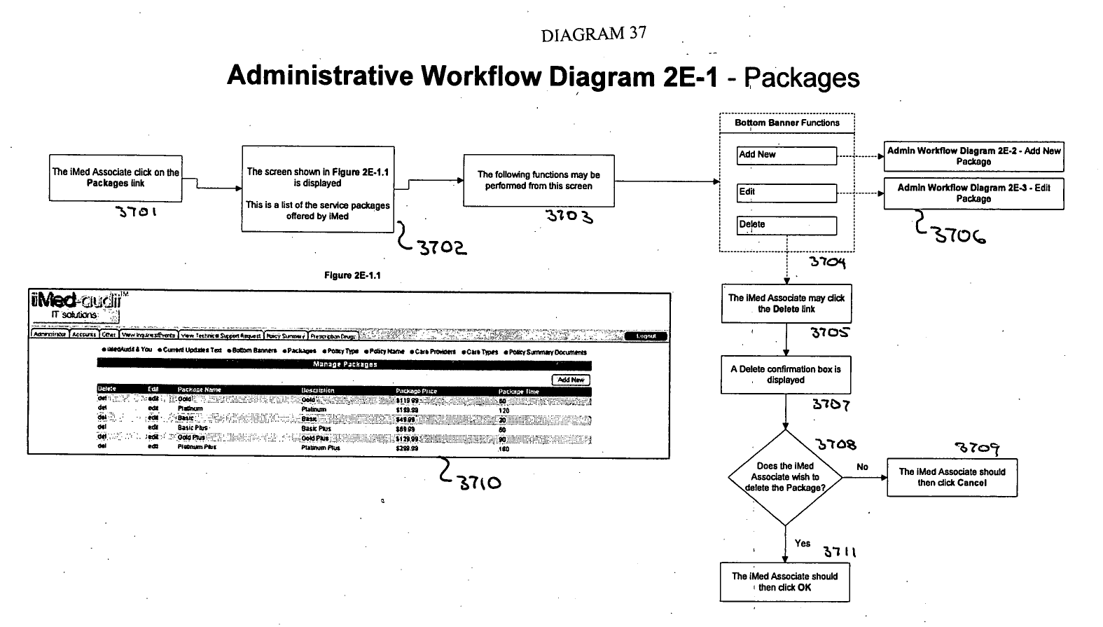

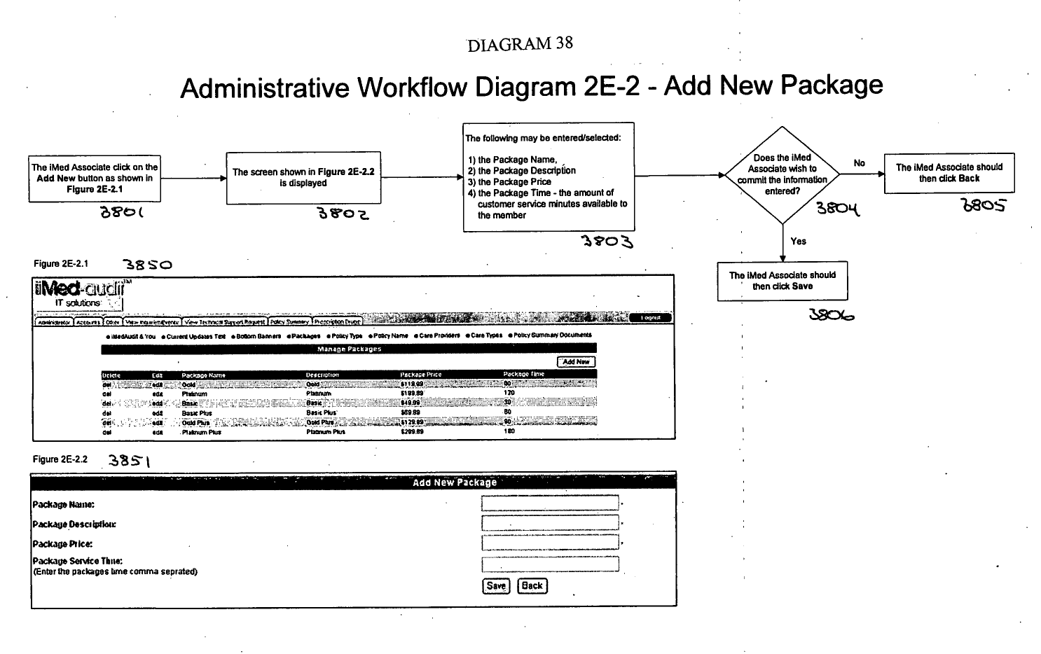

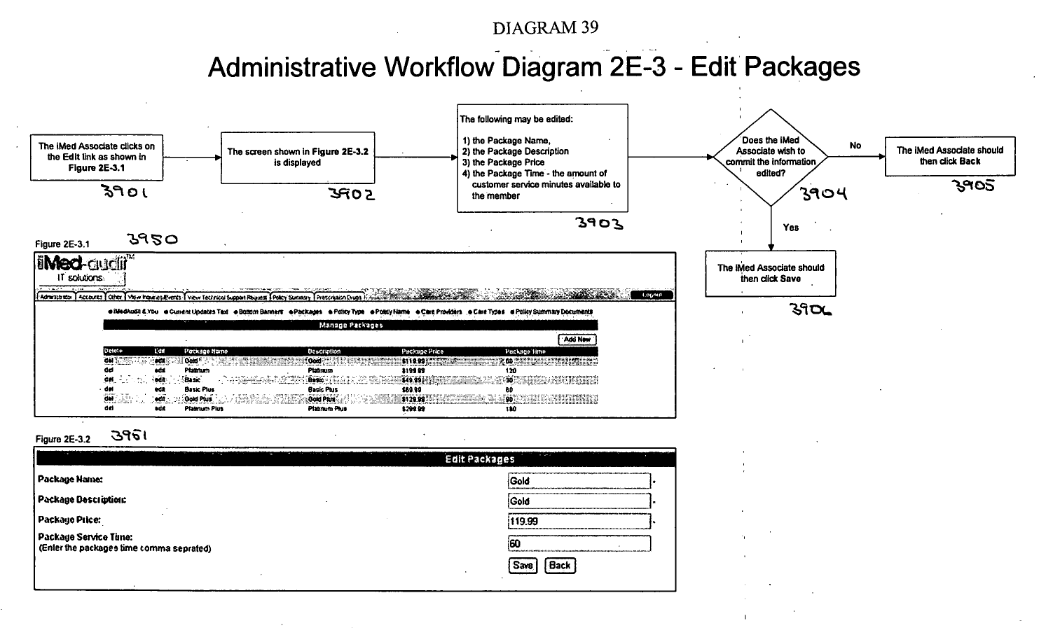

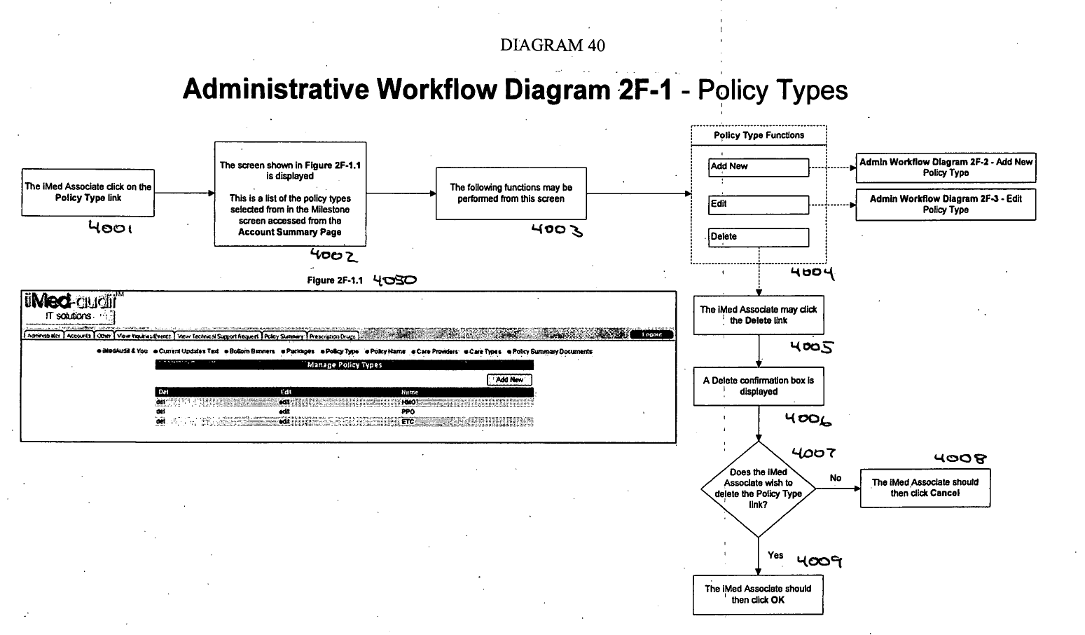

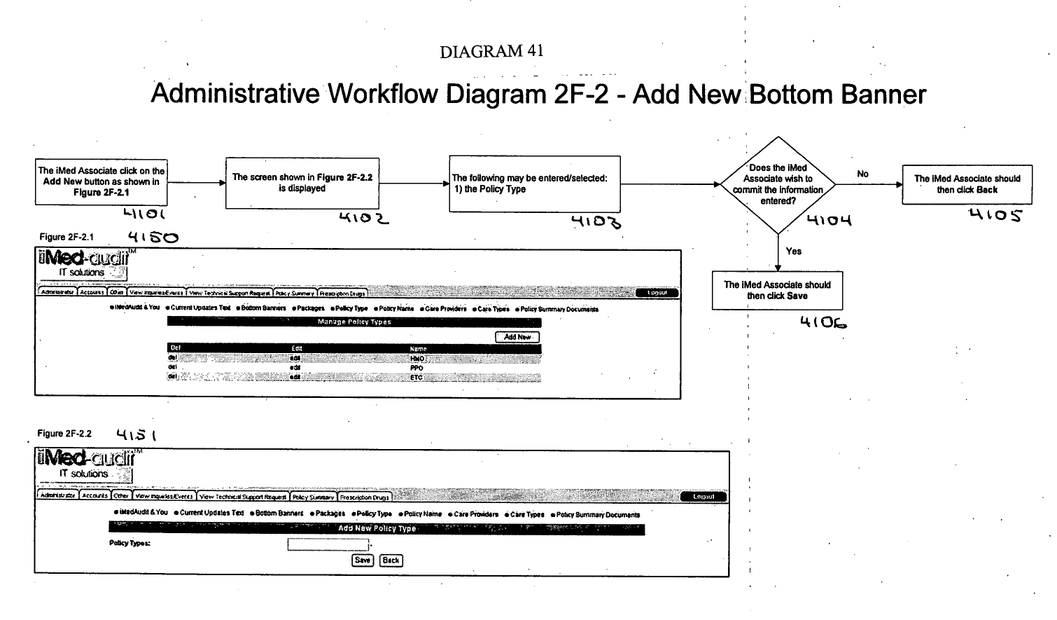

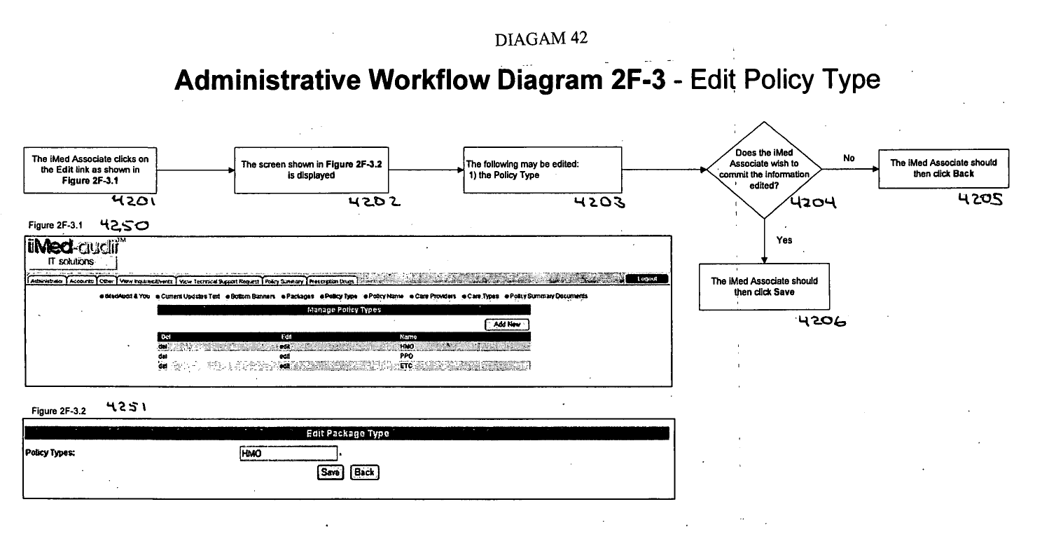

Diagram 10A illustrates an embodiment wherein the system may present the member with a summary of the insurance policy. In the embodiment illustrated, the member clicks the “coverage summary” menu tab from the “policy summary” tab 1001. The member is then displayed the “coverage summary” window 1002 and FIG. 10A-1 1050. The member is queried whether the member wants to see the coverage summary 1003. If not, the member may be returned to the account page to execute anther function 1006. If yes, the member may click the link to the desired record under the “title” header 1004. In one embodiment the policy summary is presented to the member via the Internet as a pdf (portable data format) document 1005. It will be appreciated that this summary will be the product of the data inputted by the member at signup or subsequently updated. (See Diagram 10B) In addition, the summary will include information and policy details from the system's internal data base of insurance policy coverage and terms. This database may be continuously updated and supplemented through communications obtained from corporate or group plan members and directly from insurers utilizing the member authorizations and consents.

Diagram 10B illustrates another embodiment through which a member may update milestone information. See also Diagram 4C. From the account page, the member clicks the “iMed Modify” menu on the policy summary tab 1010. The “edit milestone information” page is displayed 1011 and FIG. 10B-1 1051. The member may make the desired modifications 1012 and the changed settings submitted 1013.

Diagram 10C illustrates an embodiment wherein the member is provided through the internet with the actual insurance policy. In the embodiment, the policy is provided as a pdf (portable data format) document. The member may access the policy from the account page by clicking on “actual policy” menu in the “policy summary” tab 1020. The window depicted in FIG. 10C-1 1052 is displayed 1021. The member may chose to view the policy 1022 and the member may click on the link to the desired record under the “title” header 1023. The policy may be displayed as a pdf document 1024.

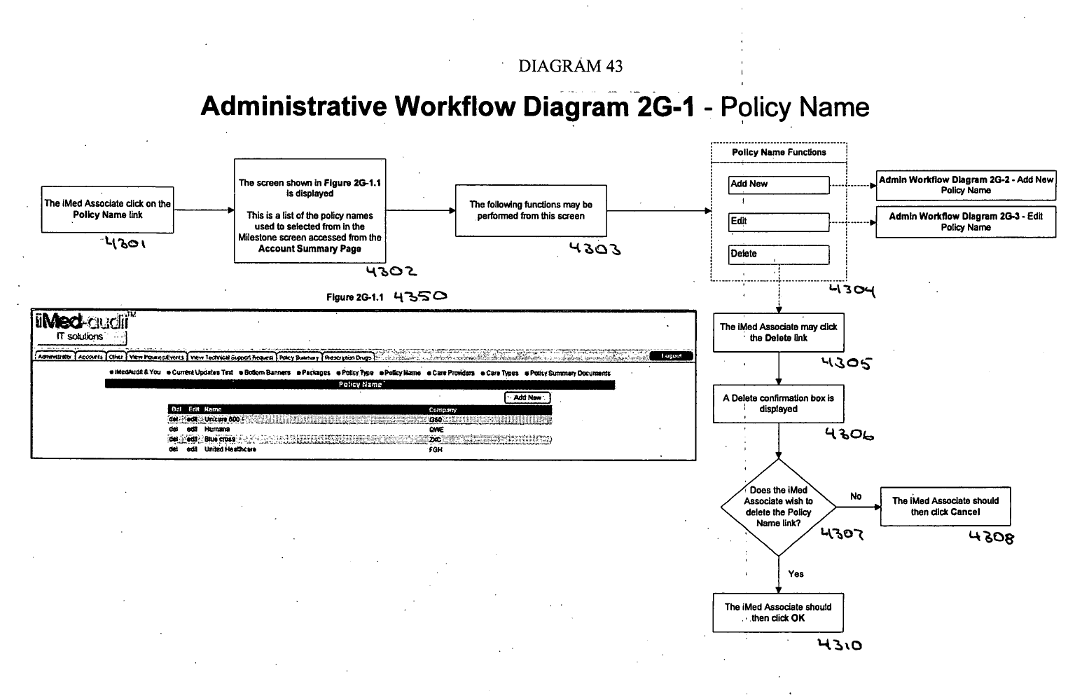

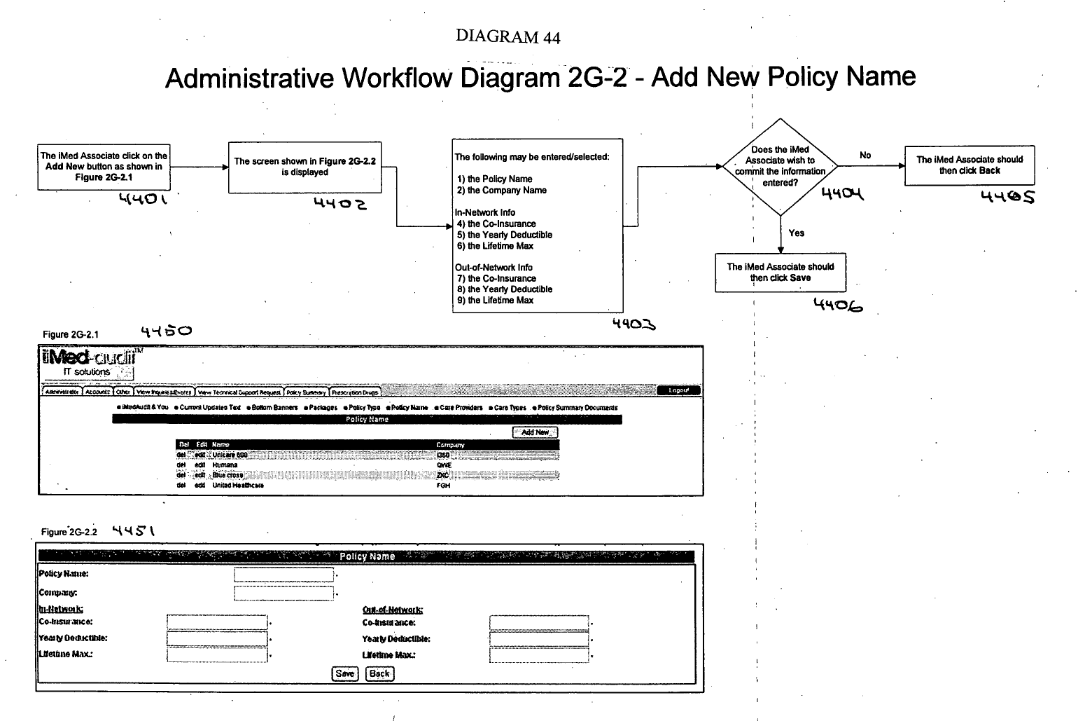

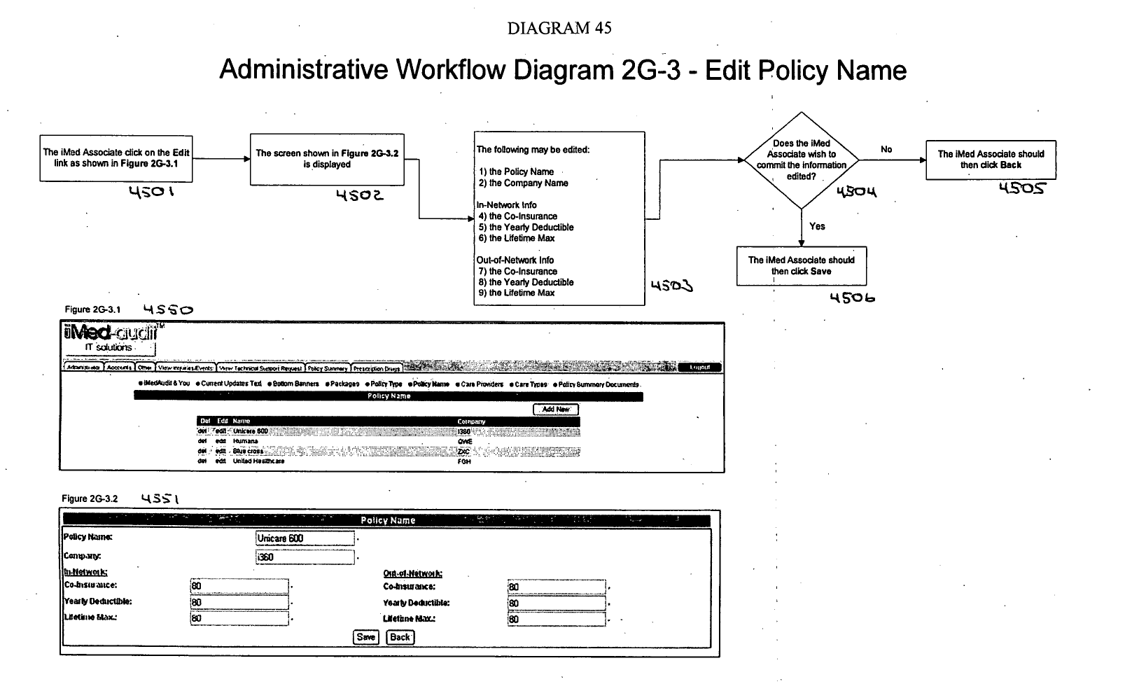

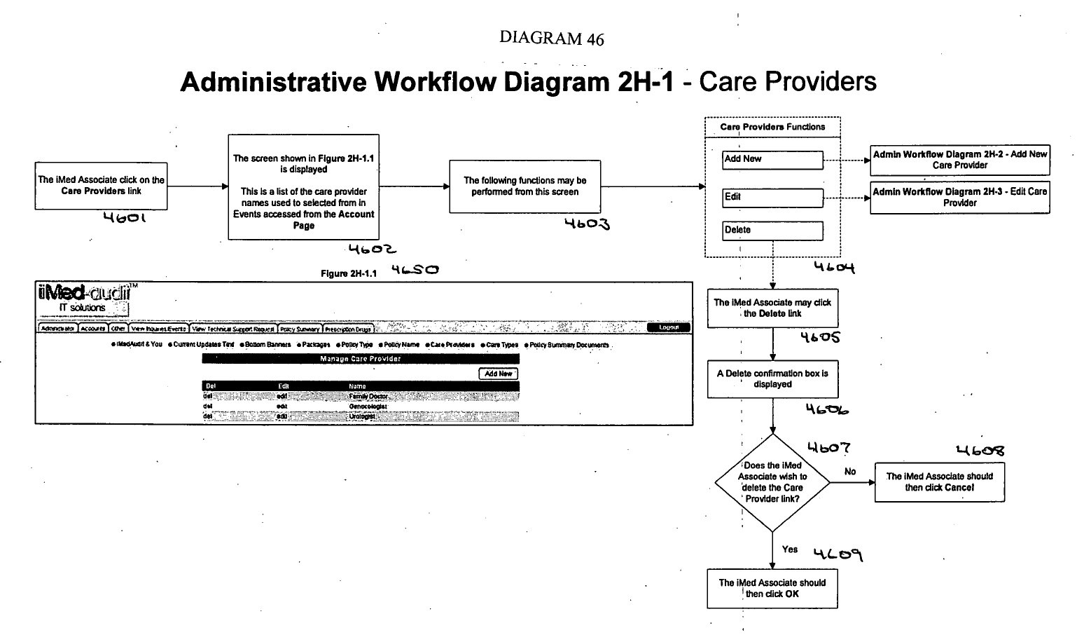

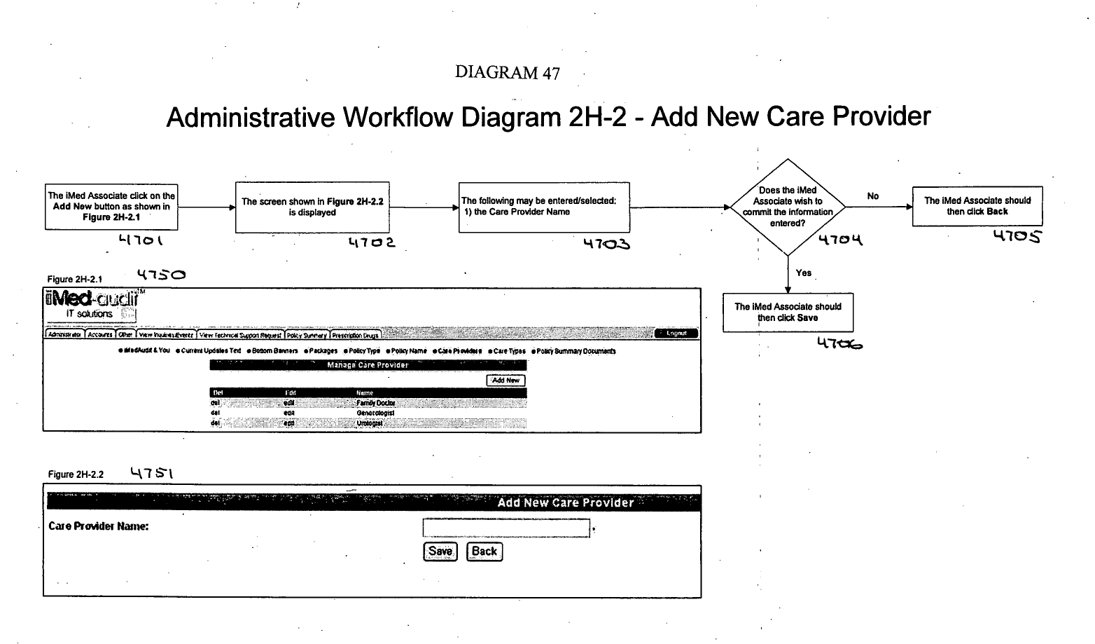

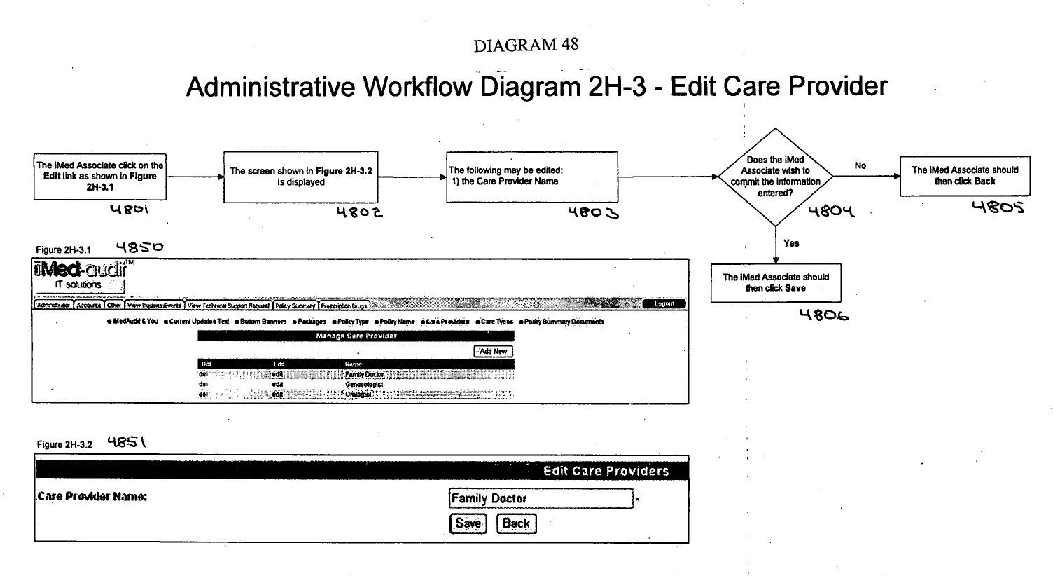

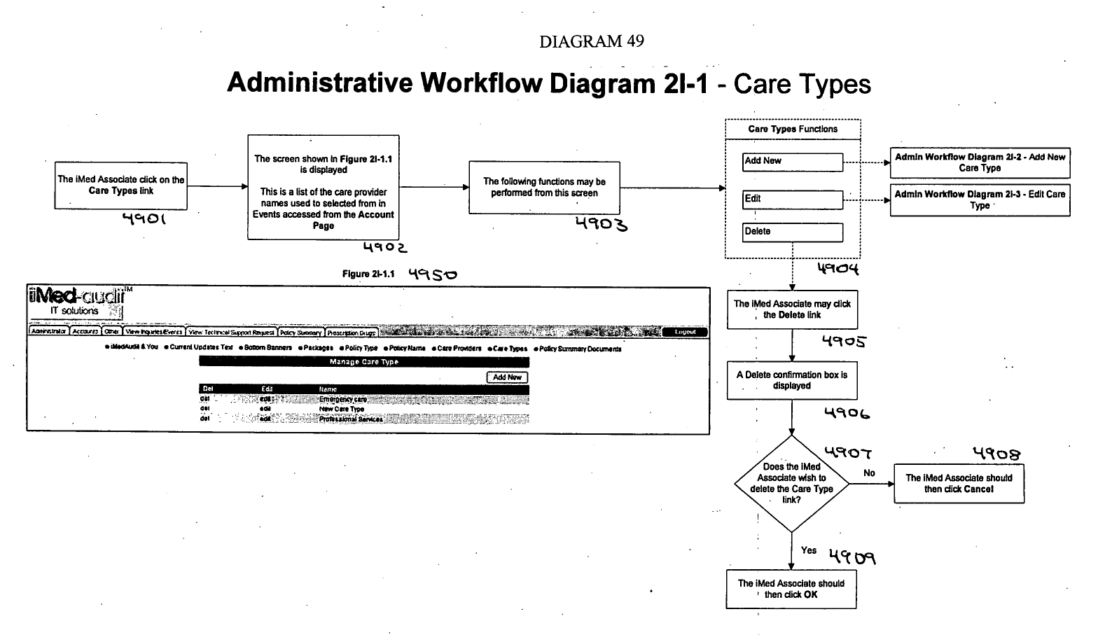

Diagram 11A entitled “iMed Prescription Creation” illustrates an embodiment wherein the member may click “new prescription” from the “new event” tab of the account page” 1111. The window illustrated in FIG. 11A-1 1150 is then displayed 1112. The member may enter the desired data and click “submit” 1113 and a prescription record is then created as shown in FIG. 11A-2 1151. The member is queried if he/she wants to view or modify the prescription record 1115. If no, the member is returned to the account page 1116. If the member wants to view or modify the prescription record 1117, the steps illustrated in Diagram 11B are implemented.

Diagram 11B also illustrates steps beginning from the account page wherein the member clicks on “prescription drug” tab 1120. The member is then displayed a list of prescription records with information 1121 as diagrammed in FIG. 11B-1 1151. The member is queried whether he/she wants to see the details of the prescription records. If no, the member is returned to the account page 1124. If yes, the member may click “+view details” link shown in the desired event record 1123. A window is opened (as shown in FIG. 11B-2 1152) displaying the prescription information. The member may elect to make changes 1126 and the member clicks “edit” button 1127. Window (depicted as FIG. 11B-3) is opened displaying the current information along with the data 1128. The member may modify any data and then click “submit” 1129.

Diagram 12 A illustrates the password security requirements 1201 of a system associate entering the system

Diagrams 12A through 56 outline the steps of the application program comprising one embodiment of the system.

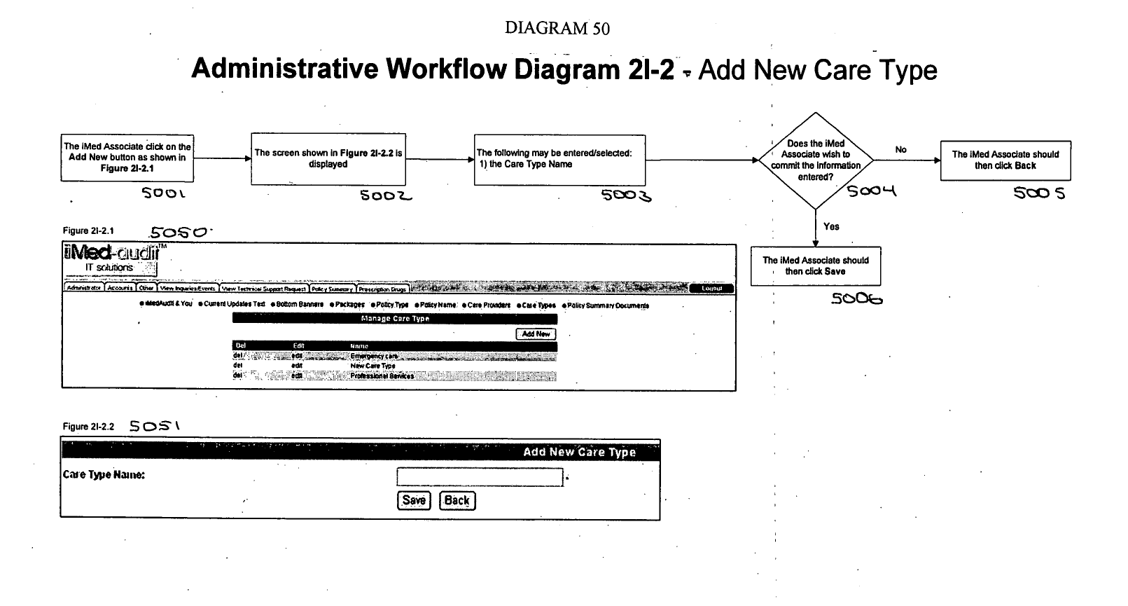

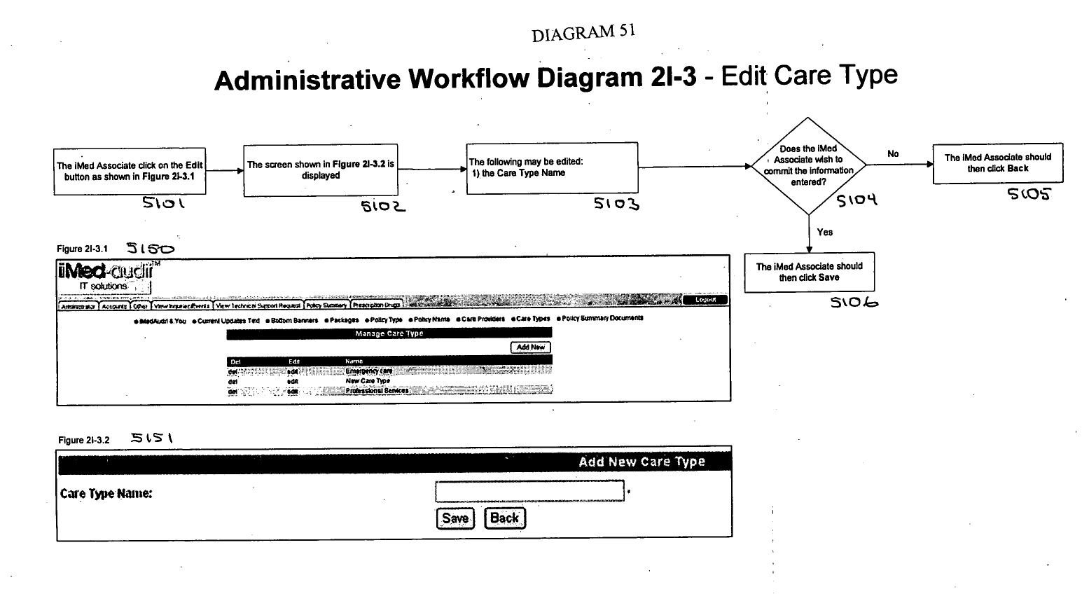

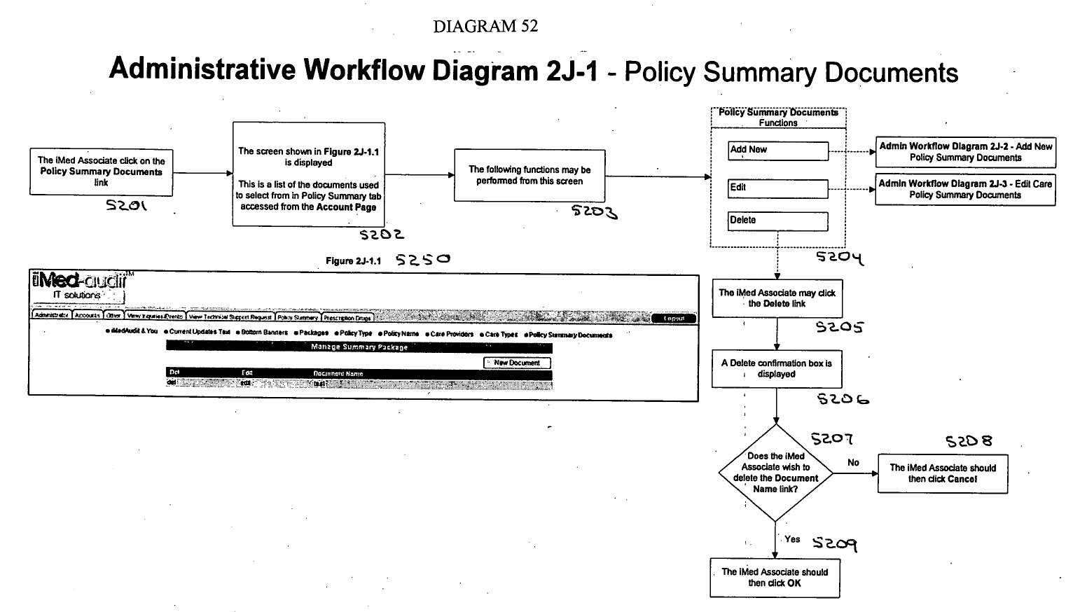

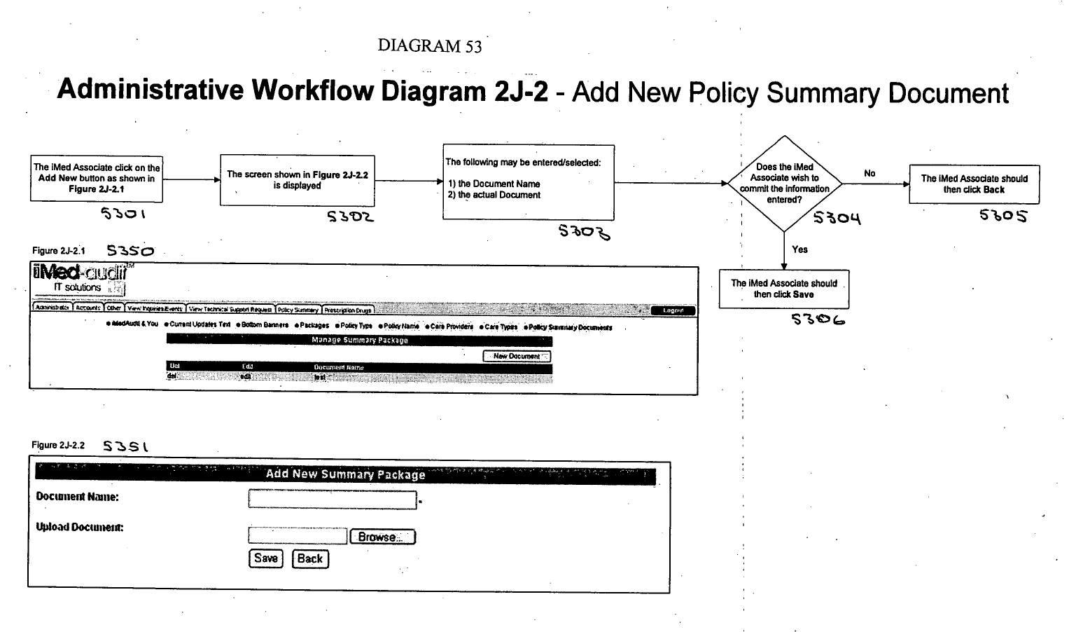

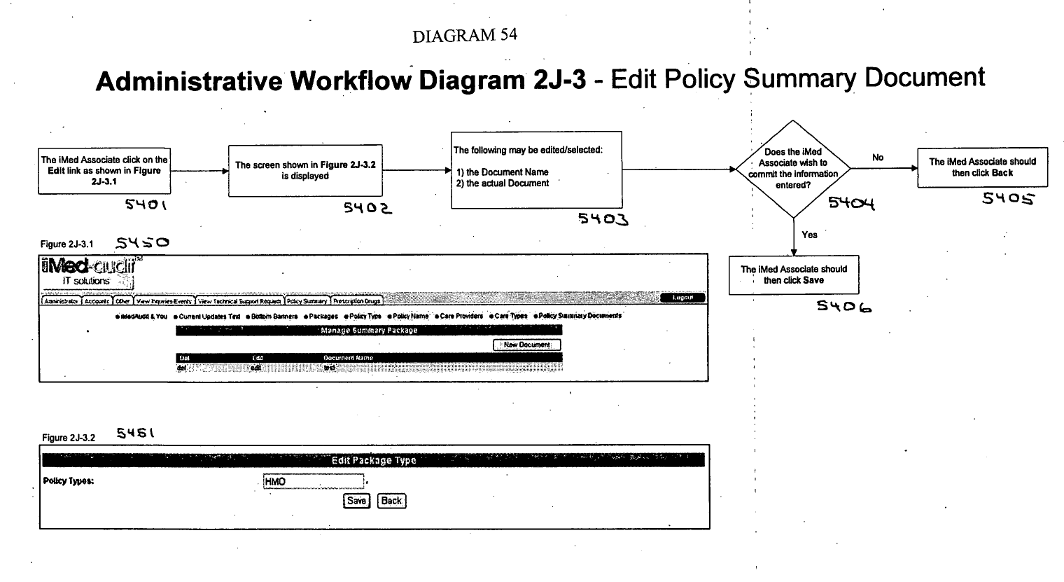

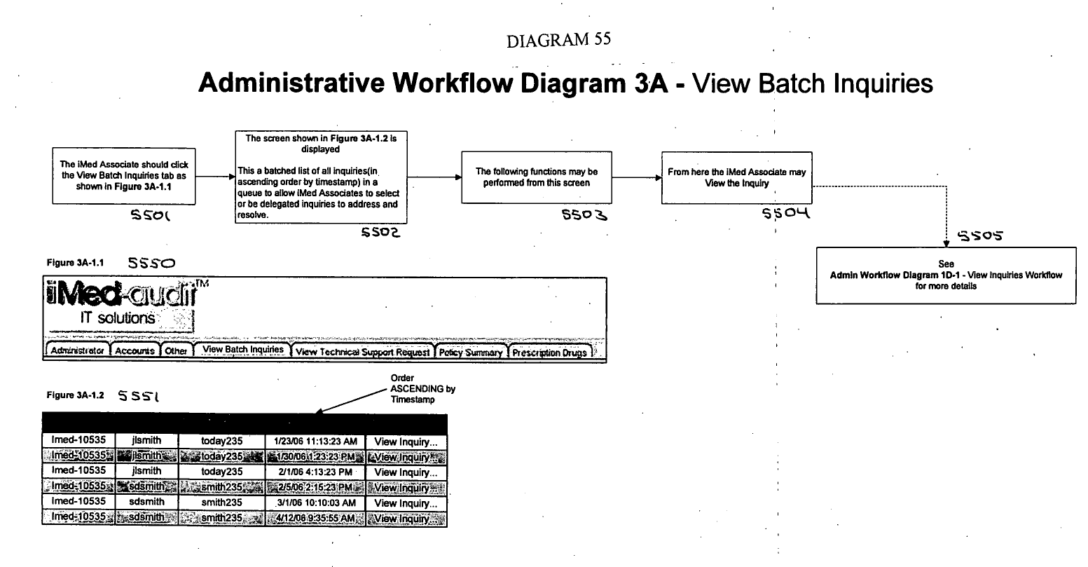

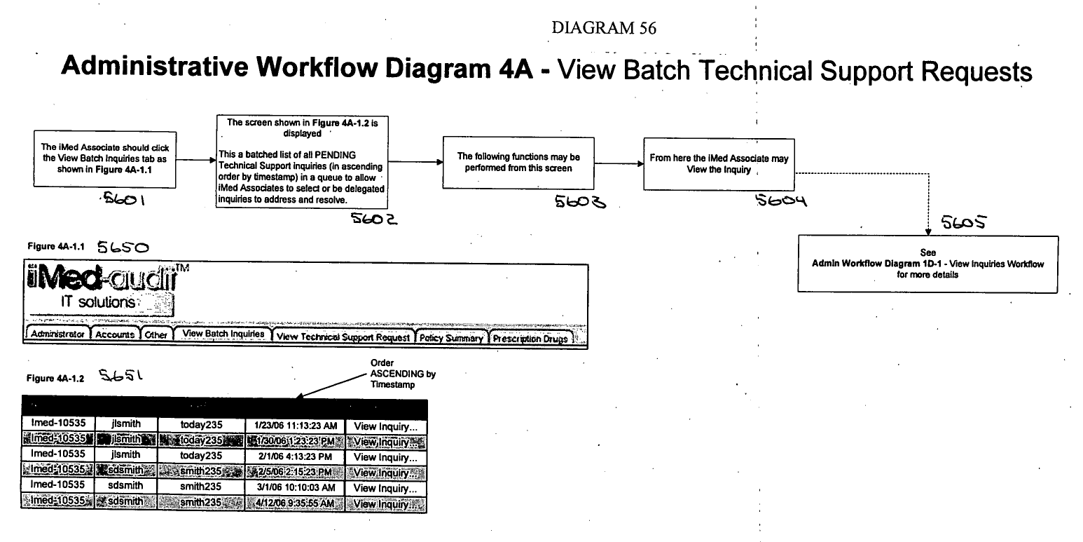

Diagram 19 illustrates the ability of the system associate to track and store all inquires. Diagram 20 through 23 illustrates the ability of the associate to edit a member's account. FIG. 24 illustrates the ability of the associate to transmit a member password to the member.

Diagram 25 illustrates the administrative function of maintaining and updating account payment information 2503. This function allows the member to acquire additional customer service or ombudsman service minutes.

Diagram 26 illustrates the ability of the application program to permit modifications 2603 of insurance contract milestones which may be used in the evaluation of medical events.

Diagram 37 illustrates an example 3710 of different membership packages which may be purchased by members. It will be appreciated that different quantities of customer service minutes may be included within each package. Members may modify 3706 the membership package. Reference is also made to Diagrams 38 and 39.

Diagrams 40 through 51 illustrate the steps that are offered by one embodiment of the application program for editing the health insurance contract information including type of contract.

Diagrams 52 through 54 pertain to the system displays of contract summaries.

Diagrams 55 and 56 illustrate the history of technical support and member inquiries.

While this invention is susceptible of embodiments in many different forms, there are shown in the drawings and will herein be described in detail preferred embodiments of the invention with the understanding that the present disclosure is to be considered an exemplification of the principles of the invention and is not intended to limit the broad aspect of the invention to the embodiments illustrated. The above general description and the following detailed description are merely illustrative of the subject invention and additional modes, advantages and particulars of this invention will be readily suggested to those skilled in the art without departing from the spirit and scope of the invention.

While specific embodiments have been illustrated and described, numerous modifications are possible without departing from the spirit of the invention, and the scope of protection is only limited by the scope of the accompanying claims.

What is claimed is

1. A system for monitoring insurance contract payment for health care expenses comprising:
a) enrolling a member in a medical insurance contract monitoring service;
b) inputting insurance contract information of a health insurer;
c) receiving medical event information for the member;
d) evaluating medical event information with the insurance contract information;
e) calculating an insurance contract payment obligation from the medical event information; and
f) communicating to the member if an insurance payment differs from calculated insurance payment obligation.

2. The system of claim 1 further comprising an application program performing steps (a) through (f).

3. The system of claim 1 further including notifying the insurer on behalf of the member when the system communicates that an insurance payment differs from calculated insurance payment obligation.

4. The system of claim 1 further comprising inquiring to the health insurer regarding an actual insurance payment different from the calculated insurance payment obligation.

5. The system of claim 4 further comprising serving as an ombudsman between the member and the health insurer.

6. The system of claim 4 wherein the ombudsman inquires of the health care provider or employer.

7. The system of claim 6 wherein the ombudsman collects information from the health care provider, insurer, member, or employer.

8. The system of claim 7 wherein the ombudsman transmits information to the insurer.

9. The system of claim 5 further comprising the ombudsman mediating an actual insurance payment different from the calculated insurance payment obligation.

10. The system of claim 5 further comprising storing information on at least one server.

11. A health benefit ombudsman service comprising the steps of
a) receiving health insurance contract information,
b) receiving an inquiry from an insured regarding the health insurance contract,
c) collecting information from a database of health provider information or health insurance contract information; and
d) communicating information and the inquiry to the insurer.

12. The ombudsman service of claim 11 further comprising requesting information from the insurer.

13. The ombudsman service of claim 11 further comprising requesting information from a health care provider.

14. The ombudsman service of claim 11 wherein the service is provided to a paid member of a health insurance monitoring service.

15. A medical insurer payment monitoring and resolution system comprising:
a) establishing representation authority
b) entering an policy payment obligations;
c) entering medical expense event information;
d) calculating an insurer payment obligation for the medical expense event;
e) entering an actual insurer payment for the medical expense event;
f) evaluating the actual insurer payment with the insurance payment obligation;
g) marking a payment evaluation for inquiry if actual insurance payment is less than the insurance payment obligation;
h) communicating to the insurer a marked evaluation of actual insurance payment with event payment obligation; and
i) initiating resolution of marked evaluation.

16. The system of claim 15 wherein resolution comprises mediation.

17. An member subscription health insurance payment data collection and evaluation apparatus comprising:
a) at least one computer server having an interface for communication over a computer network and further comprising at least one CPU with data input and display capability;
b) an application program collecting and displaying member information, health insurance contract information, medical event information, evaluating medical event information and health insurance contract information, issuing alerts of payment non compliance; and
c) a memory component for storing data for access by an application program being executed on a CPU comprising a data structure including member name, member health insurance contract, member medical event, evaluation of health insurance contract to medical event and evaluation resolution.

18. The apparatus of claim 17 further comprising a login and password control center for controlling assess to members and system associates.

19. The apparatus of claim 17 further comprising a mechanism for membership or subscription payment.

20. The apparatus of claim 17 further comprising a component for email communication.
